(19) United States
(12) Patent Application Publication
(10) Pub. No.: US 2023/0370709 A1
(43) Pub. Date: Nov. 16, 2023

(54) IMAGING DEVICE, INFORMATION PROCESSING DEVICE, IMAGING SYSTEM, AND IMAGING METHOD

(71) Applicant: SONY SEMICONDUCTOR SOLUTIONS CORPORATION, KANAGAWA (JP)

(72) Inventors: TAKAYOSHI OZONE, TOKYO (JP); KAZUTO HIROSE, TOKYO (JP)

(21) Appl. No.: 18/246,182

(22) PCT Filed: Sep. 29, 2021
(86) PCT No.: PCT/JP2021/035780

§ 371 Date: Mar. 21, 2023

(30) Foreign Application Priority Data
Oct. 8, 2020 (JP) 2020-170725

(51) Int. Cl. H04N 23/60

(52) U.S. Cl. CPC H04N 23/60

(57) ABSTRACT

To suppress a transfer delay. An imaging device according to an embodiment includes an image sensor (101) that acquires image data and a control unit (102) that controls the image sensor. The control unit causes the image sensor to execute second imaging based on one or more imaging regions determined based on the image data acquired by causing the image sensor to execute first imaging and resolution determined for each of the imaging regions. Each of the imaging regions is a partial region of an effective pixel region in the image sensor.

### FIELD

The present disclosure relates to an imaging device, an information processing device, an imaging system, and an imaging method.

### BACKGROUND

In recent years, according to the automation of mobile bodies such as automobiles and robots and the spread of Internet of Things (IoT) and the like, it has been strongly desired to increase the speed and accuracy of image recognition.

### CITATION LIST

### Patent Literature

Patent Literature 1: JP 2008-172441 A

### SUMMARY

### Technical Problem

In recent years, an amount of data treated in image recognition has been dramatically increasing according to an increase in resolution and gradation of an imaging device. Consequently, the amount of data transferred from the imaging device to a recognition device or the like increases. As a result, a deficiency such as a transfer delay has occurred.

Therefore, the present disclosure proposes an imaging device, an information processing device, an imaging system, and an imaging method capable of suppressing a transfer delay.

### Solution to Problem

To solve the problems described above, an imaging device according to an embodiment of the present disclosure includes: an image sensor configured to acquire image data; and a control unit that controls the image sensor, wherein the control unit causes the image sensor to execute second imaging based on one or more imaging regions determined based on image data acquired by causing the image sensor to execute first imaging and resolution determined for each of the imaging regions, and each of the imaging regions is a partial region of an effective pixel region in the image sensor.

### BRIEF DESCRIPTION OF DRAWINGS

FIG. 1 is a block diagram illustrating a configuration example of a vehicle control system.

FIG. 2 is a diagram illustrating an example of a sensing region.

FIG. 3 is a block diagram illustrating an overview of a recognition system according to a first embodiment.

FIG. 4 is a block diagram illustrating a schematic configuration example of an imaging device according to the first embodiment.

FIG. 5 is a diagram for explaining general recognition processing.

FIG. 6 is a diagram for explaining the general recognition processing.

FIG. 7 is a diagram for explaining recognition processing according to the first embodiment.

FIG. 8 is a flowchart illustrating a schematic operation of a recognition system according to a first operation example of the first embodiment.

FIG. 9 is a timing chart for explaining a reduction in a recognition processing time according to the first operation example of the first embodiment.

FIG. 10 is a timing chart illustrating one frame period in FIG. 9 in more detail.

FIG. 11 is a flowchart illustrating a schematic operation of a recognition system according to a second operation example of the first embodiment.

FIG. 12 is a flowchart illustrating a schematic operation of a recognition system according to a third operation example of the first embodiment.

FIG. 13 is a flowchart illustrating a schematic operation of a recognition system according to a fourth operation example of the first embodiment.

FIG. 14 is a diagram for explaining distortion correction according to the first embodiment.

FIG. 15 is a flowchart illustrating an example of a distortion correction operation according to the first embodiment.

FIG. 16 is a diagram for explaining resolution set for each region in a first modification of the first embodiment.

FIG. 17 is a flowchart illustrating a schematic operation of a recognition system according to the first modification of the first embodiment.

FIG. 18 is a diagram for explaining resolution set for each region in a second modification of the first embodiment.

FIG. 19 is a flowchart illustrating a schematic operation of a recognition system according to the second modification of the first embodiment.

FIG. 20 is a block diagram illustrating an overview of a recognition system according to a second embodiment.

FIG. 21 is a block diagram illustrating a schematic configuration example of an imaging device according to the second embodiment.

FIG. 22 is a diagram illustrating an example of image data acquired in a certain frame period in the second embodiment.

FIG. 23 is a diagram illustrating an example of image data acquired in the next frame period when the second embodiment is not applied.

FIG. 24 is a diagram illustrating an example of a differential image acquired in the next frame period when the second embodiment is applied.

FIG. 25 is a diagram for explaining reconfiguration of an entire image according to the second embodiment.

FIG. 26 is a flowchart illustrating a schematic operation of a recognition system according to a first operation example of the second embodiment.

FIG. 27 is a flowchart illustrating a schematic operation of a recognition system according to a second operation example of the second embodiment.

FIG. 28 is a schematic diagram for explaining partial regions according to a third operation example of the second embodiment.

FIG. 29 is a diagram for explaining a read operation according to a fourth operation example of the second embodiment.

FIG. 30 is a diagram for explaining a read operation according to a modification of the fourth operation example of the second embodiment.

FIG. 31 is a schematic diagram for explaining distortion correction according to the second embodiment.

FIG. 32 is a hardware configuration diagram illustrating an example of a computer that implements functions of an information processing device according to the present disclosure.

### DESCRIPTION OF EMBODIMENTS

Embodiments of the present disclosure are explained in detail below with reference to the drawings. Note that, in the embodiments explained below, redundant explanation is omitted by denoting the same parts with the same reference numerals and signs.

The present disclosure is explained according to the following item order.
1. Configuration example of a vehicle control system
2. First Embodiment
   2.1 Schematic configuration example of a recognition system
   2.2 Schematic configuration example of an imaging device
   2.3 About suppression of redundancy of a time required for recognition processing
   2.4 Operation examples
      2.4.1 First operation example
      2.4.2 Second operation example
      2.4.3 Third operation example
      2.4.4 Fourth operation example
   2.5 About distortion correction
   2.6 Action and effects
   2.7 Modification
      2.7.1 First modification
      2.7.2 Second modification
3. Second Embodiment
   3.1 Schematic configuration example of a recognition system
   3.2 Schematic configuration example of an imaging device
   3.3 About suppression of redundancy of a time required for recognition processing
   3.4 Operation examples
      3.4.1 First operation example
      3.4.2 Second operation example
      3.4.3 Third operation example
      3.4.4 Fourth operation example
         3.4.4.1 Modification of the fourth operation example
   3.5 Distortion correction
   3.6 Action and effects
4. Hardware configuration

### 1. Configuration Example of a Vehicle Control System

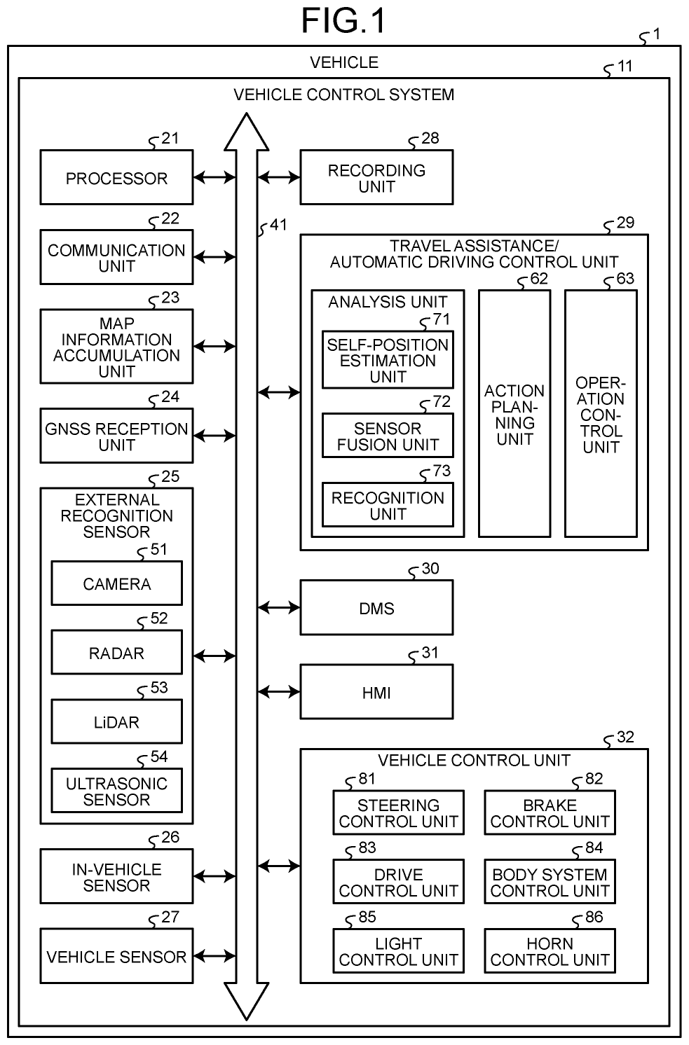

FIG. 1 is a block diagram illustrating a configuration example of a vehicle control system 11 that is an example of a mobile device control system to which the present technology is applied.

The vehicle control system 11 is provided in a vehicle 1 and performs processing related to travel assistance and automatic driving of the vehicle 1.

The vehicle control system 11 includes a vehicle control ECU (Electronic Control Unit) 21, a communication unit 22, a map information accumulation unit 23, a GNSS (Global Navigation Satellite System) reception unit 24, an external recognition sensor 25, an in-vehicle sensor 26, a vehicle sensor 27, a recording unit 28, a travel assistance/automatic driving control unit 29, a driver monitoring system (DMS) 30, a human machine interface (HMI) 31, and a vehicle control unit 32.

The vehicle control ECU 21, the communication unit 22, the map information accumulation unit 23, the GNSS reception unit 24, the external recognition sensor 25, the in-vehicle sensor 26, the vehicle sensor 27, the recording unit 28, the travel assistance/automatic driving control unit 29, the DMS 30, the HMI 31, and the vehicle control unit 32 are communicably connected to one another via a communication network 41. The communication network 41 is configured by, for example, a vehicle-mounted communication network, a bus, or the like conforming to a digital bidirectional communication standard such as a CAN (Controller Area Network), a LIN (Local Interconnect Network), a LAN (Local Area Network), FlexRay (registered trademark), or Ethernet (registered trademark). The communication network 41 may be properly used according to a type of data to be communicated. For example, the CAN is applied to data concerning vehicle control and the Ethernet is applied to large-capacity data. Note that each unit of the vehicle control system 11 may be directly connected not via the communication network 41 but by using wireless communication that assumes communication at a relatively short distance, such as near field communication (NFC) or Bluetooth (registered trademark).

Note that, in the following explanation, when the units of the vehicle control system 11 perform communication via the communication network 41, description of the communication network 41 is omitted. For example, when the vehicle control ECU 21 and the communication unit 22 perform communication via the communication network 41, it is simply described that the processor 21 and the communication unit 22 perform communication.

The vehicle control ECU 21 is configured by, for example, various processors such as a CPU (Central Processing Unit) and an MPU (Micro Processing Unit). The vehicle control ECU 21 controls the entire or a part of functions of the vehicle control system 11.

The communication unit 22 communicates with various devices inside and outside the vehicle, other vehicles, a server, a base station, and the like and transmits and receives various data. At this time, the communication unit 22 can perform communication using a plurality of communication schemes.

Communication with the outside of the vehicle executable by the communication unit 22 is schematically explained. The communication unit 22 communicates with a server (hereinafter referred to as external server) or the like present on an external network via a base station or an access point according to a wireless communication scheme such as 5G (a 5th generation mobile communication system), LTE (Long Term Evolution), or DSRC (Dedicated Short Range Communications). The external network with which the communication unit 22 performs communication is, for example, the Internet, a Cloud network, a network specific to a company, or the like. A communication scheme for performing communication to the external network by the communication unit 22 is not particularly limited as long as the communication scheme is a wireless communication scheme capable of performing digital bidirectional communication at communication speed equal to or higher than predetermined communication speed and at a distance equal to or longer than a predetermined distance.

For example, the communication unit 22 can communicate with a terminal present near the own vehicle using a P2P (Peer to Peer) technology. The terminal present near the own vehicle is, for example, a terminal worn by a moving body moving at relatively low speed such as a pedestrian or a bicycle, a terminal installed in a store or the like in a fixed position, or an MTC (Machine

Type Communication) terminal. Further, the communication unit 22 can also perform V2X communication. The V2X communication means, for example, communication between the own vehicle and another vehicle such as vehicle to vehicle communication between the own vehicle and another vehicle, vehicle to infrastructure communication between the own vehicle and a roadside device or the like, vehicle to home communication between the own vehicle and a home, and vehicle to pedestrian communication between the own vehicle and a terminal or the like carried by a pedestrian.

For example, the communication unit 22 can receive, from the outside, a program for updating software for controlling an operation of the vehicle control system 11 (Over The Air). The communication unit 22 can further receive map information, traffic information, information around the vehicle 1, and the like from the outside. Further, for example, the communication unit 22 can transmit information concerning the vehicle 1, information around the vehicle 1, and the like to the outside. Examples of the information concerning the vehicle 1 transmitted to the outside by the communication unit 22 include data indicating a state of the vehicle 1, a recognition result by a recognition unit 73, and the like. Further, for example, the communication unit 22 performs communication corresponding to a vehicle emergency call system such as an eCall.

Communication with the inside of the vehicle executable by the communication unit 22 is schematically explained. The communication unit 22 can communicate with the devices in the vehicle using, for example, wireless communication. The communication unit 22 can perform wireless communication with the devices in the vehicle according to a communication scheme capable of performing digital bidirectional communication at communication speed equal to or higher than a predetermined communication speed through wireless communication such as wireless LAN, Bluetooth, NFC, or WUSB (Wireless USB). Not only this, but the communication unit 22 can also communicate with the devices in the vehicle using wired communication. For example, the communication unit 22 can communicate with the devices in the vehicle through wired communication via a cable connected to a not-illustrated connection terminal. The communication unit 22 can communicate with the devices in the vehicle according to a communication scheme capable of performing digital bidirectional communication at communication speed equal to or higher than predetermined communication speed through wired communication such as a USB (Universal Serial Bus), an HDMI (High-Definition Multimedia Interface) (registered trademark), or an MHL (Mobile High-Definition Link).

Here, the devices in the vehicle indicate, for example, devices not connected to the communication network 41 in the vehicle. As the devices in the vehicle, for example, a mobile device and a wearable device carried by an occupant such as a driver, an information device brought into the vehicle and temporarily installed, and the like are assumed.

For example, the communication unit 22 receives an electromagnetic wave transmitted by a road traffic information communication system (VICS (Vehicle Information and Communication System) (registered trademark) such as a radio wave beacon, an optical beacon, or FM multiplex broadcast.

The map information accumulation unit 23 accumulates one or both of a map acquired from the outside and a map created by the vehicle 1. For example, the map information accumulation unit 23 accumulates a three-dimensional high-precision map, a global map having lower accuracy than the high-precision map and covering a wide area, and the like.

The high-precision map is, for example, a dynamic map, a point Cloud map, a vector map, or the like. The dynamic map is, for example, a map including four layers of dynamic information, semi-dynamic information, semi-static information, and static information and is provided to the vehicle 1 from the external server or the like. The point Cloud map is a map configured by point Clouds (point group data). Here, the vector map indicates a map adapted to an ADAS (Advanced Driver Assistance System) in which traffic information such as lanes and the positions of traffic lights are associated with the point Cloud map.

The point Cloud map and the vector map may be provided from, for example, the external server or the like or may be created by the vehicle 1 as a map for performing matching with a local map explained below based on a sensing result by a radar 52, a LiDAR 53, or the like and accumulated in the map information accumulation unit 23. When the high-precision map is provided from the external server or the like, for example, map data of several hundred meters square concerning a planned path on which the vehicle 1 is about to travel is acquired from the external server or the like in order to reduce a communication capacity.

The GNSS reception unit 24 receives a GNSS signal from a GNSS satellite and acquires position information of the vehicle 1. The received GNSS signal is supplied to the travel assistance/automatic driving control unit 29. Note that the GNSS reception unit 24 is not limited to a scheme using the GNSS signal and may acquire the position information using, for example, a beacon.

The external recognition sensor 25 includes various sensors used for recognizing a situation on the outside of the vehicle 1 and supplies sensor data supplied from the sensors to the units of the vehicle control system 11. Types and the number of sensors included in the external recognition sensor 25 are optional.

For example, the external recognition sensor 25 includes a camera 51, a radar 52, a LiDAR (Light Detection and Ranging, Laser Imaging Detection and Ranging) 53, and an ultrasonic sensor 54. Not only this, but the external recognition sensor 25 may be configured to include one or more types of sensors among the camera 51, the radar 52, the LiDAR 53, and the ultrasonic sensor 54. The numbers of cameras 51, radars 52, LiDAR 53, and ultrasonic sensors 54 are not particularly limited if these can be practically installed in the vehicle 1. Types of the sensor included in the external recognition sensor 25 are not limited to this example. The external recognition sensor 25 may include other types of sensors. An example of sensing regions of the sensors included in the external recognition sensor 25 is explained below.

Note that a photographing scheme of the camera 51 is not particularly limited if the photographing scheme is a photographing scheme capable of performing distance measurement. For example, as the camera 51, cameras of various photographing schemes such as a ToF (Time of Flight) camera, a stereo camera, a monocular camera, and an infrared camera can be applied according to necessary. Not only this, but the camera 51 may be a camera for simply acquiring a captured image irrespective of the distance measurement.

For example, the external recognition sensor 25 can include an environment sensor for detecting an environment for the vehicle 1. The environment sensor is a sensor for detecting environments such as weather, atmospheric phenomena, and brightness and can include various sensors such as a raindrop sensor, a fog sensor, a sunshine sensor, a snow sensor, and an illuminance sensor.

Further, for example, the external recognition sensor 25 includes a microphone used for detecting sound around the vehicle 1, a position of a sound source, and the like.

The in-vehicle sensor 26 includes various sensors for detecting information inside the vehicle and supplies sensor data supplied from the sensors to the units of the vehicle control system 11. Types and the number of the various sensors included in the in-vehicle sensor 26 are not particularly limited if the sensors can be practically installed in the vehicle 1.

For example, the in-vehicle sensor 26 can include one or more types of sensors among a camera, a radar, a seating sensor, a steering wheel sensor, a microphone, and a biological sensor. As the cameras included in the in-vehicle sensor 26, for example, cameras of various photographing schemes capable of performing distance measurement such as a ToF camera, a stereo camera, a monocular camera, and an infrared camera can be used. Not only this, but the cameras included in the in-vehicle sensor 26 may be cameras for simply acquiring a captured image irrespective of the distance measurement. The biological sensor included in the in-vehicle sensor 26 is provided in, for example, a seat or a steering wheel and detects various kinds of biological information of the occupant such as the driver.

The vehicle sensor 27 includes various sensors for detecting a state of the vehicle 1 and supplies sensor data supplied from the sensors to the units of the vehicle control system 11. Types and the number of various sensors included in the vehicle sensor 27 are not particularly limited if the sensors can be practically installed in the vehicle 1.

For example, the vehicle sensor 27 includes a speed sensor, an acceleration sensor, an angular velocity sensor (a gyro sensor), and an inertial measurement unit (IMU) obtained by integrating these sensors. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects the number of revolutions of an engine or a motor, an air pressure sensor that detects air pressure of tires, a slip rate sensor that detects a slip rate of the tires, and a wheel speed sensor that detects rotating speed of wheels. For example, the vehicle sensor 27 includes a battery sensor that detects the residual power and temperature of a battery and an impact sensor that detects an impact from the outside.

The recording unit 28 includes at least one of a nonvolatile storage medium and a volatile storage medium and stores data and programs. The recording unit 28 is used as, for example, an EEPROM (Electrically Erasable Programmable Read Only Memory) and a RAM (Random Access Memory). As the storage medium, a magnetic storage device such as an HDD (Hard Disc Drive), a semiconductor storage device, an optical storage device, and a magneto-optical storage device can be applied. The recording unit 28 records various programs and data used by the units of the vehicle control system 11. For example, the recording unit 28 includes an EDR (Event Data Recorder) and a DSSAD (Data Storage System for Automated Driving) and records information concerning the vehicle 1 before and after an event such as an accident and biological information acquired by the in-vehicle sensor 26.

The travel assistance/automatic driving control unit 29 controls travel support and automatic driving of the vehicle 1. For example, the travel assistance/automatic driving control unit 29 includes an analysis unit 61, an action planning unit 62, and an operation control unit 63.

The analysis unit 61 performs analysis processing for situations of the vehicle 1 and the surroundings. The analysis unit 61 includes a self-position estimation unit 71, a sensor fusion unit 72, and a recognition unit 73.

The self-position estimation unit 71 estimates a self-position of the vehicle 1 based on sensor data supplied from the external recognition sensor 25 and the high-precision map accumulated in the map information accumulation unit 23. For example, the self-position estimation unit 71 generates a local map based on the sensor data supplied from the external recognition sensor 25 and estimates the self-position of the vehicle 1 by matching the local map with the high-precision map. The position of the vehicle 1 is based on, for example, the center of a rear wheel pair axle.

The local map is, for example, a three-dimensional high-precision map created using a technique such as SLAM (Simultaneous Localization and Mapping), an occupancy grid map, or the like. The three-dimensional high-precision map is, for example, the point Cloud map explained above. The occupancy grid map is a map in which a three-dimensional or two-dimensional space around the vehicle 1 is divided into grids of a predetermined size to indicate an occupancy state of an object in units of the grids. The occupancy state of the object is indicated by, for example, presence or absence or a presence probability of the object. The local map is also used for, for example, detection processing and recognition processing of a situation on the outside of the vehicle 1 by the recognition unit 73.

Note that the self-position estimation unit 71 may estimate the self-position of the vehicle 1 based on a GNSS signal and sensor data supplied from the vehicle sensor 27.

The sensor fusion unit 72 performs sensor fusion processing for combining a plurality of different kinds of sensor data (for example, image data supplied from the camera 51 and sensor data supplied from the radar 52) to obtain new information. As a method of combining different kinds of sensor data, there are integration, fusion, association, and the like.

The recognition unit 73 executes detection processing for detecting a situation on the outside of the vehicle 1 and recognition processing for recognizing the situation on the outside of the vehicle 1.

For example, the recognition unit 73 performs the detection processing and the recognition processing for the situation on the outside of the vehicle 1 based on information supplied from the external recognition sensor 25, information supplied from the self-position estimation unit 71, information supplied from the sensor fusion unit 72, and the like.

Specifically, for example, the recognition unit 73 performs detection processing, recognition processing, and the like for an object around the vehicle 1. The detection processing for the object is, for example, processing for detecting presence or absence, a size, a shape, a position, a movement, and the like of the object. The recognition processing for the object is, for example, processing for recognizing an attribute such as a type of the object and identifying a specific object. However, the detection processing and the recognition processing are not always clearly divided and sometimes overlap.

For example, the recognition unit 73 detects an object around the vehicle 1 by performing clustering for classifying point Clouds based on sensor data by the LiDAR 53, the radar 52, or the like into each mass of a point group. Consequently, presence or absence, a size, a shape, and a position of the object around the vehicle 1 are detected.

For example, the recognition unit 73 detects a movement of the object around the vehicle 1 by performing tracking for following a movement of the mass of the point group classified by the clustering. As a result, speed and a traveling direction (a movement vector) of the object around the vehicle 1 are detected.

For example, the recognition unit 73 detects or recognizes a vehicle, a person, a bicycle, an obstacle, a structure, a road, a traffic light, a traffic sign, a road sign, and the like with respect to image data supplied from the camera 51. A type of the object around the vehicle 1 may be recognized by performing recognition processing such as semantic segmentation.

For example, the recognition unit 73 can perform recognition processing for traffic rules around the vehicle 1 based on a map accumulated in the map information accumulation unit 23, an estimation result of the self position by the self-position estimation unit 71, and a recognition result of the object around the vehicle 1 by the recognition unit 73. With this processing, the recognition unit 73 can recognize a position and a state of a traffic light, contents of a traffic sign and a road sign, contents of traffic rules, a travelable lane, and the like.

For example, the recognition unit 73 can perform recognition processing for an environment around the vehicle 1. As the environment around the vehicle 1 to be recognized by the recognition unit 73, weather, temperature, humidity, brightness, a state of a road surface, and the like are assumed.

The action planning unit 62 creates an action plan of the vehicle 1. For example, the action planning unit 62 creates an action plan by performing processing for path planning and path following.

Note that global path planning is processing for planning a rough path from a start to a goal. This path planning is called track planning and includes processing of local path planning that enables safe and smooth traveling near the vehicle 1 considering motion characteristics of the vehicle 1 in the path planned by the path planning. The path planning may be distinguished from long-term path planning and the startup generation may distinguished from short-term path planning or local path planning. A safety preference path represents a concept similar to the startup generation, the short-term path planning, or the local path planning.

The path following is processing for planning an operation for safely and accurately traveling on a path planned by the path planning within a planned time. The action planning unit 62 can calculate target speed and target angular velocity of the vehicle 1 based on, for example, a result of the path following processing.

The operation control unit 63 controls an operation of the vehicle 1 in order to realize the action plan created by the action planning unit 62.

For example, the operation control unit 63 controls a steering control unit 81, a brake control unit 82, and a drive control unit 83 included in the vehicle control unit 32 explained below and performs acceleration/deceleration control and direction control such that the vehicle 1 travels on a track calculated by the track planning. For example, the operation control unit 63 performs cooperative control for the purpose of implementing functions of an ADAS such as collision avoidance or shock absorbing, follow-up traveling, vehicle speed maintaining traveling, collision warning of the own vehicle, lane deviation warning of the own vehicle, and the like. For example, the operation control unit 63 performs cooperative control for the purpose of automatic driving or the like for autonomously travelling without depending on operation of the driver.

The DMS 30 performs authentication processing for the driver, recognition processing for a state of the driver, and the like based on sensor data supplied from the in-vehicle sensor 26, input data input to the HMI 31 explained below, and the like. In this case, as the state of the driver to be recognized by the DMS 30, for example, a physical condition, a wakefulness level, a concentration level, a fatigue level, a line-of-sight direction, a drunkenness level, driving operation, a posture, and the like are assumed.

Note that the DMS 30 may perform authentication processing for an occupant other than the driver and recognition processing of a state of the occupant. For example, the DMS 30 may perform recognition processing of a situation inside the vehicle based on sensor data supplied from the in-vehicle sensor 26. As the situation inside the vehicle to be recognized, for example, temperature, humidity, brightness, odor, and the like are assumed.

The HMI 31 inputs various data, instructions, and the like and presents various data to the driver or the like.

Data input by the HMI 31 is schematically explained. The HMI 31 includes an input device for a person to input data. The HMI 31 generates an input signal based on data, an instruction, or the like input by an input device and supplies the input signal to the units of the vehicle control system 11. The HMI 31 includes operation pieces such as a touch panel, a button, a switch, and a lever as the input device. Not only this, but the HMI 31 may further include an input device capable of inputting information with a method other than manual operation by voice, gesture, or the like. Further, the HMI 31 may use, as the input device, for example, a remote control device using infrared rays or radio waves or an external connection device such as a mobile device or a wearable device adapted to operation of the vehicle control system 11.

Presentation of data by the HMI 31 is schematically explained. The HMI 31 generates visual information, auditory information, and tactile information for an occupant or the outside of the vehicle. The HMI 31 performs output control for controlling an output, output content, output timing, an output method, and the like of these kinds of generated information. The HMI 31 generates and outputs, as the visual information, for example, an operation screen, state display of the vehicle 1, warning display, an image such as a monitor image indicating a situation around the vehicle 1, and information indicated by light. The HMI 31 generates and outputs, as the auditory information, information indicated by sounds such as voice guidance, warning sound, and a warning message. Further, the HMI 31 generates and outputs, as the tactile information, information given to the tactile sense of the occupant by, for example, force, vibration, or movement.

As an output device with which the HMI 31 outputs visual information, for example, a display device that presents visual information by displaying an image by itself or a projector device that presents visual information by projecting an image can be applied. Note that the display device may be a device that displays visual information in the field of view of the passenger such as a head-up display, a transmissive display, or a wearable device having an AR (Augmented Reality) function in addition to a display device including a normal display. In the HMI 31, a display device included in a navigation device, an instrument panel, a CMS (Camera Monitoring System), an electronic mirror, a lamp, or the like provided in the vehicle 1 can also be used as an output device that outputs visual information.

As the output device with which the HMI 31 outputs the auditory information, for example, an audio speaker, a headphone, or an earphone can be applied.

As the output device with which the HMI 31 outputs the tactile information, for example, a haptics element using a haptics technology can be applied. The haptics element is provided in, for example, a portion with which the occupant of the vehicle 1 comes into contact such as a steering wheel or a seat.

The vehicle control unit 32 controls the units of the vehicle 1. The vehicle control unit 32 includes a steering control unit 81, a brake control unit 82, a drive control unit 83, a body system control unit 84, a light control unit 85, and a horn control unit 86.

The steering control unit 81 detects and controls a state of a steering system of the vehicle 1. The steering system includes, for example, a steering mechanism including a steering wheel and the like and an electric power steering. The steering control unit 81 includes, for example, a control unit such as an ECU that controls the steering system, an actuator that drives the steering system, and the like.

The brake control unit 82 performs detection, control, and the like of a state of the brake system of the vehicle 1. The brake system includes, for example, a brake mechanism including a brake pedal and the like, an ABS (Antilock Brake System), and a regenerative brake mechanism. The brake control unit 82 includes, for example, a control unit such as an ECU that controls a brake system.

The drive control unit 83 performs detection, control, and the like of a state of a drive system of the vehicle 1. The drive system includes, for example, a driving force generation device for generating a driving force such as an accelerator pedal, an internal combustion engine, or a driving motor, a driving force transmission mechanism for transmitting the driving force to wheels, and the like. The drive control unit 83 includes, for example, a control unit such as an ECU that controls the drive system.

The body system control unit 84 performs detection, control, and the like of a state of a body system of the vehicle 1. The body system includes, for example, a keyless entry system, a smart key system, a power window device, a power seat, an air conditioner, an airbag, a seat belt, a shift lever, and the like. The body system control unit 84 includes, for example, a control unit such as an ECU that controls the body system.

The light control unit 85 performs detection, control, and the like of states of various lights of the vehicle 1. As the lights to be controlled, for example, a headlight, a backlight, a fog light, a turn signal, a brake light, a projection, and a display of a bumper are assumed. The light control unit 85 includes a control unit such as an ECU that performs light control.

The horn control unit 86 performs detection, control, and the like of a state of a car horn of the vehicle 1. The horn control unit 86 includes, for example, a control unit such as an ECU that controls the car horn.

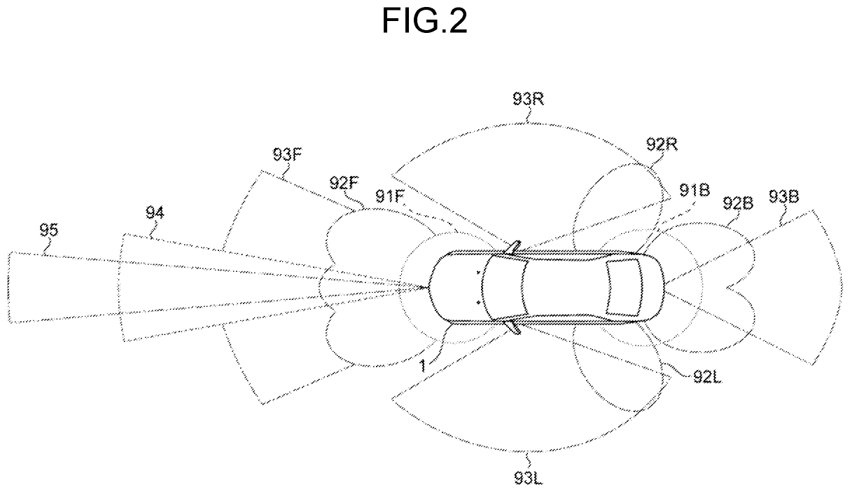

FIG. 2 is a diagram illustrating an example of a sensing region by the camera 51, the radar 52, the LiDAR 53, the ultrasonic sensor 54, and the like of the external recognition sensor 25 illustrated in FIG. 1. Note that FIG. 2 schematically illustrates a state in which the vehicle 1 as viewed from above, where the left end side is the front end (front) side of the vehicle 1 and the right end side is the rear end (rear) side of the vehicle 1.

A sensing region 91F and a sensing region 91B indicate examples of a sensing region of the ultrasonic sensor 54. The sensing region 91F covers the front end periphery of the vehicle 1 with a plurality of ultrasonic sensors 54. The sensing region 91B covers the rear end periphery of the vehicle 1 with a plurality of ultrasonic sensors 54.

Sensing results in the sensing region 91F and the sensing region 91B are used, for example, for parking assistance of the vehicle 1.

A sensing region 92F and a sensing region 92B indicate examples of sensing regions of the radar 52 for a short distance or a middle distance. The sensing region 92F covers up to a position farther than the sensing region 91F in the front of the vehicle 1. The sensing region 92B covers up to a position farther than the sensing region 91B in the rear of the vehicle 1. A sensing region 92L covers the rear periphery of the left side surface of the vehicle 1. A sensing region 92R covers the rear periphery of the right side surface of the vehicle 1.

A sensing result in the sensing region 92F is used to, for example, detect a vehicle, a pedestrian, or the like present in the front of the vehicle 1. A sensing result in the sensing region 92B is used for, for example, a collision prevention function or the like in the rear of the vehicle 1. Sensing results in the sensing region 92L and the sensing region 92R are used to, for example, detect an object in blind spots on the sides of the vehicle 1.

The sensing region 93F and a sensing region 93B indicate examples of sensing regions by the camera 51. The sensing region 93F covers up to a position farther than the sensing region 92F in the front of the vehicle 1. The sensing region 93B covers up to a position farther than the sensing region 92B in the rear of the vehicle 1. A sensing region 93L covers the periphery of the left side surface of the vehicle 1. A sensing region 93R covers the periphery of the right side surface of the vehicle 1.

A sensing result in the sensing region 93F can be used for, for example, recognition of a traffic light or a traffic sign, a lane deviation prevention assist system, and an automatic headlight control system. The sensing result in the sensing region 93B can be used for, for example, parking assistance and a surround view system. Sensing results in the sensing region 93L and the sensing region 93R can be used for, for example, a surround view system.

A sensing region 94 indicates an example of a sensing region of the LiDAR 53. The sensing region 94 covers up to a position farther than the sensing region 93F in the front of the vehicle 1. On the other hand, the sensing region 94 has a narrower range in the left-right direction than the sensing region 93F.

A sensing result in the sensing region 94 is used for, for example, detecting an object such as a vehicle in the periphery.

A sensing region 95 indicates an example of a sensing region of the long-range radar 52. The sensing region 95 covers up to a position farther than the sensing region 94 in the front of the vehicle 1. On the other hand, the sensing region 95 has a narrower range in the left-right direction than the sensing region 94.

A sensing result in the sensing region 95 is used for, for example, ACC (Adaptive Cruise Control), emergency braking, and collision avoidance.

Note that the sensing regions of the sensors of the camera 51, the radar 52, the LiDAR 53, and the ultrasonic sensor 54 included in the external recognition sensor 25 may have various configurations other than the configurations illustrated in FIG. 2. Specifically, the ultrasonic sensor 54 may sense the sides of the vehicle 1 or the LiDAR 53 may sense the rear of the vehicle 1. In addition, installation positions of the sensors are not limited to the examples explained above. The numbers of sensors may be one or may be plural.

In the configuration explained above, when the external recognition sensor 25 (for example, the camera 51) is increased in resolution and gradation, an amount of data treated in image recognition dramatically increases. Consequently, for example, an amount of data transferred from the external recognition sensor 25 to the recognition unit 73 of the travel assistance/automatic driving control unit 29 via the communication network 41 increases. As a result, a deficiency such as a transfer delay can occur. This directly leads to redundancy of a time required for recognition processing. Therefore, this is a problem to be solved particularly in a recognition system mounted on a device requiring real-time performance such as a vehicle-mounted device or an autonomous mobile body.

Therefore, in embodiments explained below, an imaging device, an information processing device, an imaging system, and an imaging method that enable suppression of a transfer delay are proposed. Note that the vehicle control system explained above is only an example of an application destination of the embodiments explained below. That is, the embodiments explained below can be applied to various devices, systems, methods, programs, and the like involving transfer of data such as image data.

### 2. First Embodiment

First, a first embodiment of the present disclosure is explained in detail with reference to the drawings. The present embodiment illustrates a case in which traffic in transferring image data acquired by an imaging device that acquires a color image or a monochrome image is reduced.

2.1 Schematic Configuration Example of a Recognition System

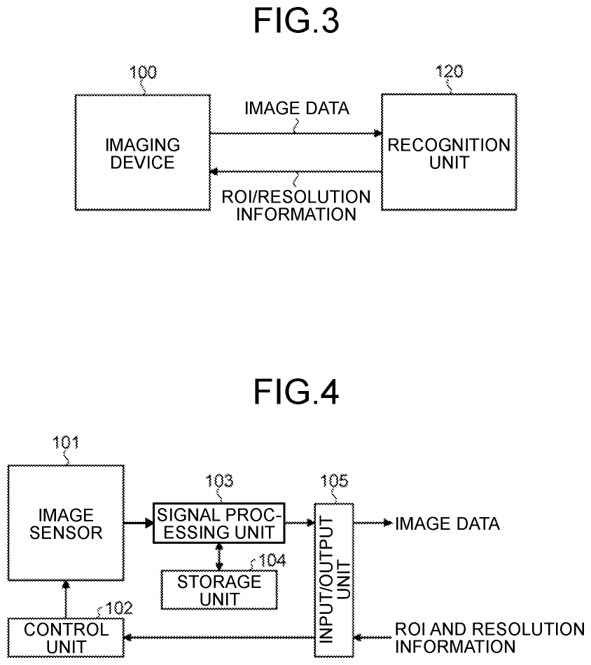

FIG. 3 is a block diagram illustrating an overview of the recognition system according to the present embodiment. As illustrated in FIG. 3, the recognition system includes an imaging device 100 and a recognition unit 120. The recognition unit 120 can be equivalent to, for example, an example of the processing unit in the claims.

The imaging device 100 is equivalent to, for example, the camera 51, the in-vehicle sensor 26, and the like explained above with reference to FIG. 1 and generates and outputs image data of a color image or a monochrome image. The output image data is input to the recognition unit 120 via a predetermined network such as the communication network 41 explained above with reference to FIG. 1.

The recognition unit 120 is equivalent to, for example, the recognition unit 73 and the like explained above with reference to FIG. 1 and detects an object, a background, and the like included in an image by executing recognition processing on image data input from the imaging device 100. Note that the object may include, besides a moving object such as an automobile, a bicycle, or a pedestrian, a fixed object such as a building, a house, or a tree. On the other hand, the background may be a region in a wide range located in the distance such as sky, mountains, plains, or the sea.

The recognition unit 120 determines a region of the object or a region of the background obtained as a result of the recognition processing on the image data as an ROI (Region of Interest) that is a partial region of an effective pixel region in an image sensor 101. In addition, the recognition unit 120 determines resolution of ROIs. Then, the recognition unit 120 notifies the imaging device 100 of information concerning the determined ROI and the determined resolution (hereinafter referred to as ROI/resolution information) to set, in the imaging device 100, a ROI to be read and resolution at the time when image data is read from the ROIs.

Note that the information concerning the ROI may be, for example, information concerning an address of a pixel serving as a starting point of the ROI and sizes in the vertical and horizontal directions. In that case, the ROIs are rectangular regions. However, not only this, but the ROI may be a circle, an ellipse, or a polygon or may be an indefinite-shape region specified by information for designating a boundary (a contour). When a plurality of ROIs are determined, the recognition unit 120 may determine different resolution for each of the ROIs.

2.2 Schematic Configuration Example of an Imaging Device

FIG. 4 is a block diagram illustrating a schematic configuration example of the imaging device according to the present embodiment. As illustrated in FIG. 4, the imaging device 100 includes an image sensor 101, a control unit 102, a signal processing unit 103, a storage unit 104, and an input/output unit 105. Note that one or more of the control unit 102, the signal processing unit 103, the storage unit 104, and the input/output unit 105 may be provided on a chip on which the image sensor 101 is provided.

Although not illustrated, the image sensor 101 includes a pixel array unit in which a plurality of pixels are arranged in a two-dimensional lattice shape, a drive circuit that drives the pixels, and a processing circuit that converts pixel signals read from the pixels into digital values. The image sensor 101 outputs image data read from the entire pixel array unit or the individual ROIs to the signal processing unit 103.

The signal processing unit 103 executes predetermined signal processing such as a noise reduction and white balance adjustment on the image data output from the image sensor 101.

The storage unit 104 temporarily stores image data or the like processed or unprocessed by the signal processing unit 103.

The input/output unit 105 transmits the processed or unprocessed image data input via the signal processing unit 103 to the recognition unit 120 via the predetermined network (for example, the communication network 41).

The control unit 102 controls an operation of the image sensor 101. The control unit 102 sets one or more ROIs and resolutions of the ROIs in the image sensor 101 based on the ROI/resolution information input via the input/output unit 105.

2.3 About Suppression of Redundancy of a Time Required for Recognition Processing

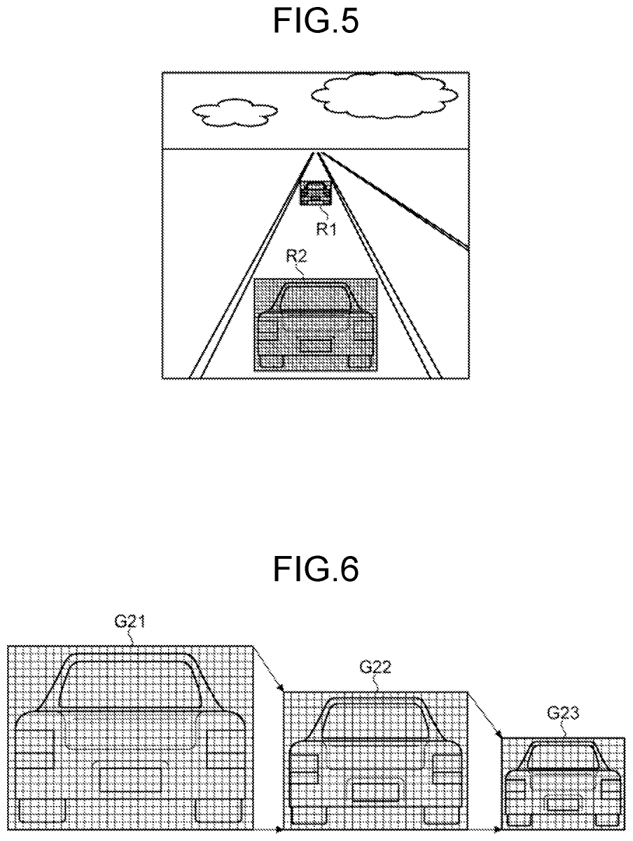

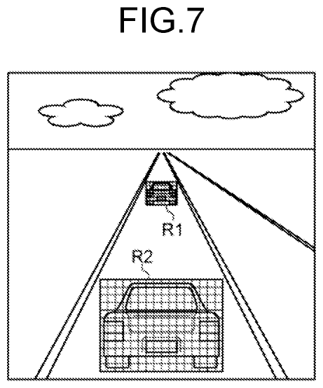

Subsequently, how to reduce an amount of data transferred from the imaging device 100 to the recognition unit 120 in the present embodiment is explained. FIG. 5 and FIG. 6 are diagrams for explaining general recognition processing. FIG. 7 is a diagram for explaining recognition processing according to the present embodiment.

In general recognition processing, segmentation of regions is executed for image data read at uniform resolution. Object recognition about what is imaged in each of the segmented regions is executed.

Here, as illustrated in FIG. 5, in a normal read operation, a region R1 for imaging an object present far away and a region R2 for imaging an object present nearby are read at the same resolution. Therefore, for example, the region R2 for imaging an object present nearby is read at resolution finer than resolution necessary for the recognition processing.

In such a case, in the general recognition processing, as illustrated in FIG. 6, processing for reducing resolution of image data G21 read from the region R2 to appropriate resolution of image data G22 or G23 is performed. This means that, in data transfer for the purpose of the recognition processing, unnecessary traffic occurs by a difference between a data amount of the image data G21, which is raw data, and a data amount of the image data G22 or G23 having resolution suitable for the recognition processing. This also means that, in the recognition processing, redundant processing such as a resolution reduction occurs.

Therefore, in the present embodiment, as illustrated in FIG. 7, in the regions R1 and R2 set as the ROIs, the image sensor 101 is operated to read, at low resolution, the region R2 for imaging an object present nearby. Consequently, it is possible to reduce traffic from the imaging device 100 to the recognition unit 120 and it is possible to omit redundant processing such as a resolution reduction. Therefore, it is possible to suppress redundancy of a time required for the recognition processing.

In the present embodiment, by executing a read operation targeting the regions R1 and R2 set as the ROIs with the recognition unit 120, it is possible to further reduce a data amount of image data read from the image sensor 101. Consequently, it is also possible to further reduce traffic from the imaging device 100 to the recognition unit 120.

2.4 Operation Examples

Subsequently, several operation examples of the recognition system according to the present embodiment are explained.

2.4.1 First Operation Example

In a first operation example, first, a case is explained in which image data is read at low resolution from the entire region of the image sensor 101 and, thereafter, a region such as an object is set as an ROI and read at appropriate resolution.

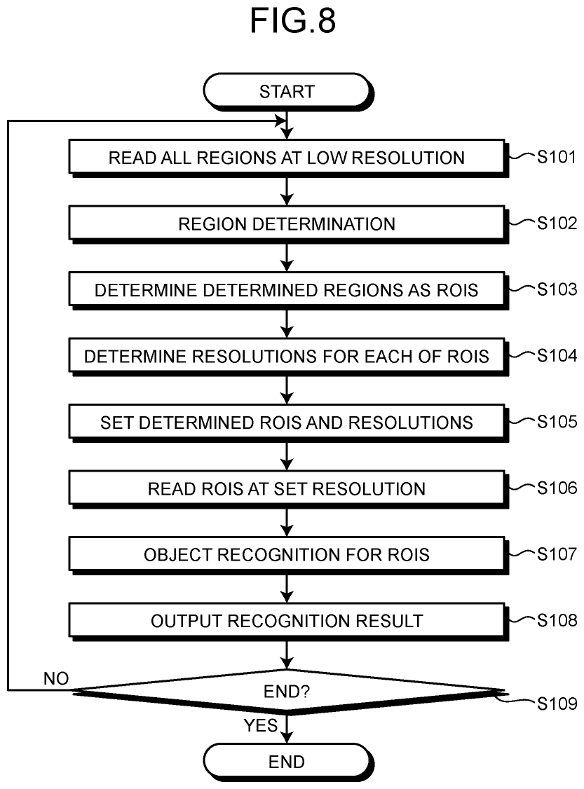

FIG. 8 is a flowchart illustrating a schematic operation of a recognition system according to the first operation example of the present embodiment. As illustrated in FIG. 8, in this operation, first, the control unit 102 of the imaging device 100 executes reading of image data from the image sensor 101 at low resolution lower than the maximum resolution of the image sensor 101 (step S101). The read low-resolution image data (hereinafter referred to as low-resolution image data) may be image data read from the entire effective pixel region (hereinafter also referred to as entire region) of the pixel array unit. As a reading method with low resolution, for example, a method such as thinning reading for skipping one or more columns of pixels in a row and/or column direction and driving the pixel columns, or binning for treating two or more adjacent pixels as one pixel to increase detection sensitivity may be used.

Note that, for the binning, there are various methods such as a method of combining signals read from two or more adjacent pixels and a method of sharing one floating diffusion region in two or more adjacent pixels. However, any method may be used. By adopting the thinning reading, the number of pixels to be driven is reduced. Therefore, a reading time of low-resolution image data can be reduced. By adopting the binning, it is possible to improve an SN ratio in addition to the reduction in the read time by a reduction in the number of driven pixels and a reduction in an exposure time.

The low-resolution image data read in step S101 is subjected to predetermined processing such as a noise reduction and white balance adjustment in the signal processing unit 103 and, thereafter, input to the recognition unit 120 via the predetermined network such as the communication network 41. At that time, since image data to be transferred is the low-resolution image data, traffic at the time of transfer is reduced. The recognition unit 120 executes region determination on the input low-resolution image data (step S102). For this region determination, a method such as semantic segmentation may be used. In this region determination, regions where objects or the like are present may be specified.

Subsequently, the recognition unit 120 determines, as ROIs, the regions determined in the region determination in step S102 (step S103).

Subsequently, the recognition unit 120 determines, for each of the ROIs determined in step S104, resolution at the time when image data is read from regions on the image sensor 101 corresponding to the ROIs (step S104). At that time, the recognition unit 120 may determine resolutions of the ROIs according to distances to the objects imaged in the ROIs. For example, the recognition unit 120 may determine that a region for imaging an object present in the distance (for example, a region R1 in FIG. 7) has high resolution and determine that a region for imaging an object present in the vicinity (for example, the region R2 in FIG. 7) has low resolution. Note that a region for imaging an object located in the middle between the distance and the vicinity may be determined as having a resolution in the middle between the high resolution and the low resolution (hereinafter also referred to as intermediate resolution). Note that the distances to the objects imaged in the ROIs (or whether the distances to the objects imaged in the ROIs are long or short) may be determined based on, for example, sizes of the regions where the objects are imaged or sensor information input from other sensors such as the radar 52, the LiDAR 53, and the ultrasonic sensor 54.

Subsequently, the recognition unit 120 sets, in the imaging device 100, the ROIs determined in step S103 and the resolutions of the ROIs determined in step S104 (step S105). In contrast, the control unit 102 of the imaging device 100 executes, for each of the set ROIs, reading from the ROIs at the resolutions set in the ROIs (step S106). Image data read from the ROIs is subjected to the predetermined processing such as the noise reduction and the white balance adjustment in the signal processing unit 103 and, thereafter, input to the recognition unit 120 via the predetermined network. At that time, since the image data to be transferred is image data of an ROI narrower than an entire region, traffic at the time of transfer is reduced.

Subsequently, the recognition unit 120 executes recognition processing on the input image data for each of the ROIs (step S107) and outputs a result of the recognition processing to the action planning unit 62, the operation control unit 63, and the like (see FIG. 1) (step S108). In the recognition processing in step S107, not the image data of the entire region but the image data of each of the ROIs is targeted. Therefore, it is possible to reduce a recognition processing time by reducing a calculation amount. Since processing of reducing excessively high resolution of image data is also omitted, the recognition processing time can be further shortened.

Thereafter, the recognition system determines whether to end this operation (step S109) and, when determining to end this operation (YES in step S109), ends this operation. On the other hand, when determining not to end this operation (NO in step S109), the recognition system returns to step S101 and executes the subsequent operations.

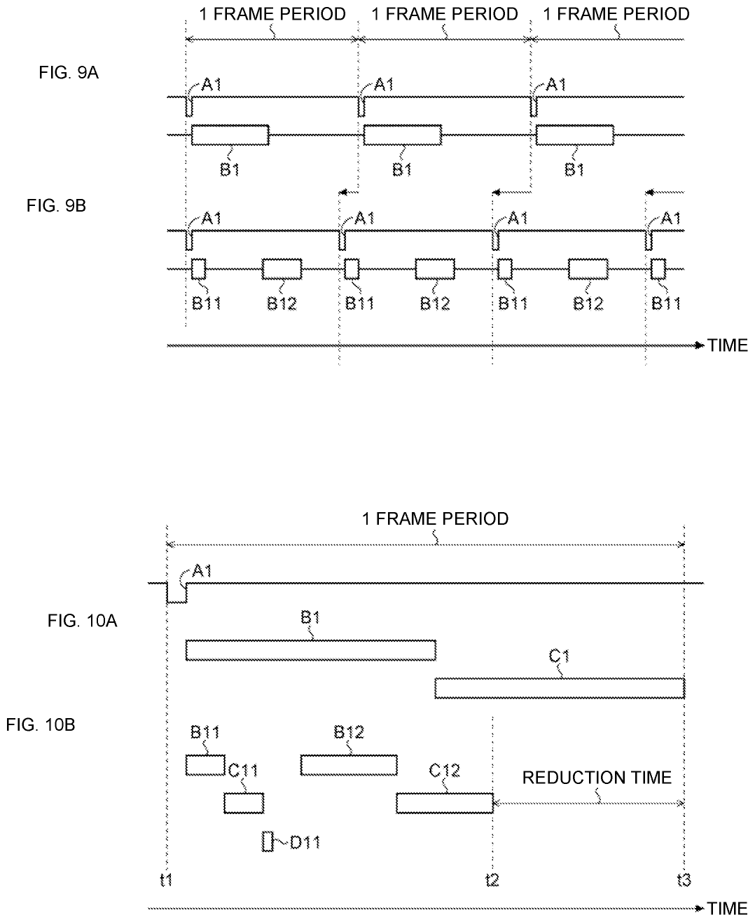

Here, a reduction in a recognition processing time according to the first operation example is explained while being compared with general recognition processing. FIG. 9 is a timing chart for explaining a reduction in a recognition processing time according to the first operation example. FIG. 10 is a timing chart illustrating one frame period in FIG. 9 in more detail. Note that, in FIG. 9 and FIG. 10, (A) illustrates the general recognition processing, and (B) illustrates the first operation example.

As illustrated in (A) of FIG. 9 and (A) of FIG. 10, in the general recognition processing, image data is read from the entire region of the image sensor 101 with high resolution. Therefore, a read period B1 following a synchronization signal A1, which is the heads of the frame periods, is long and a recognition processing period C1 for the read image data is also long.

On the other hand, as illustrated in (B) of FIG. 9 and (B) of FIG. 10, in the recognition processing according to the first operation example, first, the image data is read from the entire region of the image sensor 101 at low resolution. Therefore, a first read period B11 following the synchronization signal A1 is short and a recognition processing period (region determination) C11 for the read low-resolution image data is also short. Then, after a transfer period D11 for ROI/resolution information, image data is read from the ROIs (a read period B12) and recognition processing (a recognition processing period C12) for the read image data for each of the ROIs is executed. Therefore, the read period B12 and the recognition processing period C12 can be reduced. As a result, since it is possible to reduce one frame period from a reading start to recognition processing completion, it is possible to realize recognition processing at a higher frame rate and higher accuracy of the recognition processing.

2.4.2 Second Operation Example

In a second operation example, a case is explained in which image data is read at high resolution from the entire region of the image sensor 101 at a rate of once in several frames and, in other frames, reading of a necessary region is executed based on ROIs and resolutions used in the immediately preceding frame or frames before the immediately preceding frame. Note that, in the following explanation, the same operations as the operation examples explained above are cited to omit redundant explanation.

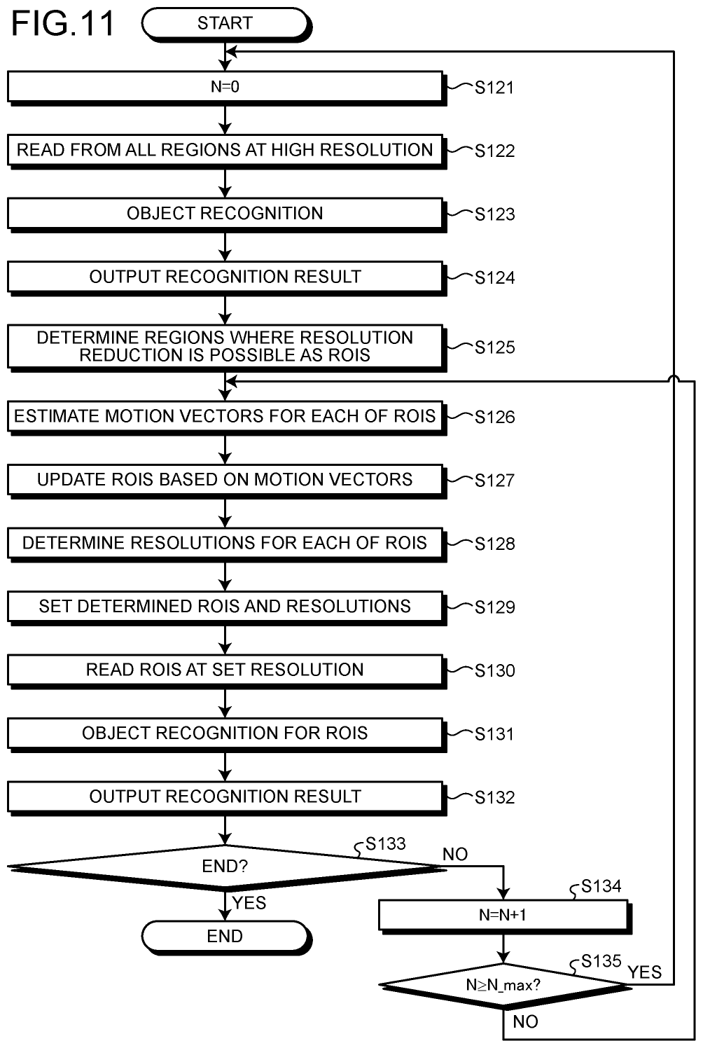

FIG. 11 is a flowchart illustrating a schematic operation of a recognition system according to the second operation example of the present embodiment. As illustrated in FIG. 11, in this operation, first, the control unit 102 of the imaging device 100 resets a variable N for managing a frame period for acquiring image data (hereinafter also referred to as key frame) at high resolution to 0 (N=0) (step S121).

Subsequently, the control unit 102 executes reading of the key frame from the image sensor 101 (step S122). The key frame to be read may be image data read from an entire effective pixel region (hereinafter also referred to as entire region) of the pixel array unit. Reading at high resolution may be normal reading not involving the thinning and the binning.

The key frame read in step S122 is subjected to the predetermined processing such as the noise reduction and the white balance adjustment in the signal processing unit 103 and, thereafter, input to the recognition unit 120 via the predetermined network such as the communication network 41. In contrast, the recognition unit 120 executes recognition processing on the input key frame (step S123), and outputs a result of the recognition processing to the action planning unit 62, the operation control unit 63, and the like (see FIG. 1) (step S124).

Subsequently, the recognition unit 120 determines, as ROIs, region where resolution reduction is possible among regions of objects recognized in the recognition processing in step S123 (step S125). The regions where the resolution reduction is possible may be, for example, regions where resolution reduction is necessary in the recognition processing in step S123.

Subsequently, the recognition unit 120 estimates motion vectors of the regions (or images of objects included in the regions) determined as the ROIs in step S125 (step S126), and updates the positions and sizes of the ROIs with the estimated motion vectors (step S127). Note that, in estimating the motion vectors, the motion vectors of the ROIs (or images of objects included in the ROIs) may be estimated using the current frame and one or more preceding frames.

Subsequently, for each of the ROIs updated in step S127, the recognition unit 120 determines resolutions at the time when image data is read from regions on the image sensor 101 corresponding to the ROIs (step S128). For the determination of the resolutions, for example, the same method as step S104 in FIG. 8 may be used.

Subsequently, the recognition unit 120 sets the ROIs updated in step S127 and the resolutions of the ROIs determined in step S128 in the imaging device 100 (step S129). In contrast, the control unit 102 of the imaging device 100 executes, for each of the set ROIs, reading from the ROIs at the resolutions set in the ROIs (step S130). Image data read from the ROIs is subjected to the predetermined processing such as the noise reduction and the white balance adjustment in the signal processing unit 103 and, thereafter, input to the recognition unit 120 via the predetermined network. At that time, since the image data to be transferred is image data of an ROI narrower than an entire region, traffic at the time of transfer is reduced.

Subsequently, the recognition unit 120 executes recognition processing on the input image data for each of the ROIs (step S131) and outputs a result of the recognition processing to the action planning unit 62, the operation control unit 63, and the like (see FIG. 1) (step S132). In the recognition processing in step S131, since not the image data of the entire region but the image data for each of the ROIs is targeted, the recognition processing time can be reduced by reducing the calculation amount. Since processing of reducing excessively high resolution of image data is also omitted, the recognition processing time can be further shortened.

Thereafter, the recognition system determines whether to end this operation (step S133) and, when determining to end this operation (YES in step S133), ends this operation. On the other hand, when the recognition system determines not to end this operation (NO in step S133), the control unit 102 increments the variable N by 1 (N=N+1) (step S134). Subsequently, the control unit 102 determines whether the incremented variable N has reached a preset maximum value N_max (step S135).

When the control unit 102 determines that the variable N has reached the maximum value N_max (YES in step S135), this operation returns to step S121 and the subsequent operations are executed. On the other hand, when the control unit 102 determines that the variable N has not reached the maximum value N_max (NO in step S135), this operation returns to step S126 and the subsequent operations are executed.

2.4.3 Third Operation Example

In the first and second operation examples explained above, the case is illustrated in which the ROIs are determined in the recognition unit 120. In contrast, in a third operation example, a case is illustrated in which ROIs are determined in the imaging device 100. Note that, in the following description, the same operations as any one of the operation examples explained above are cited to omit redundant explanation.

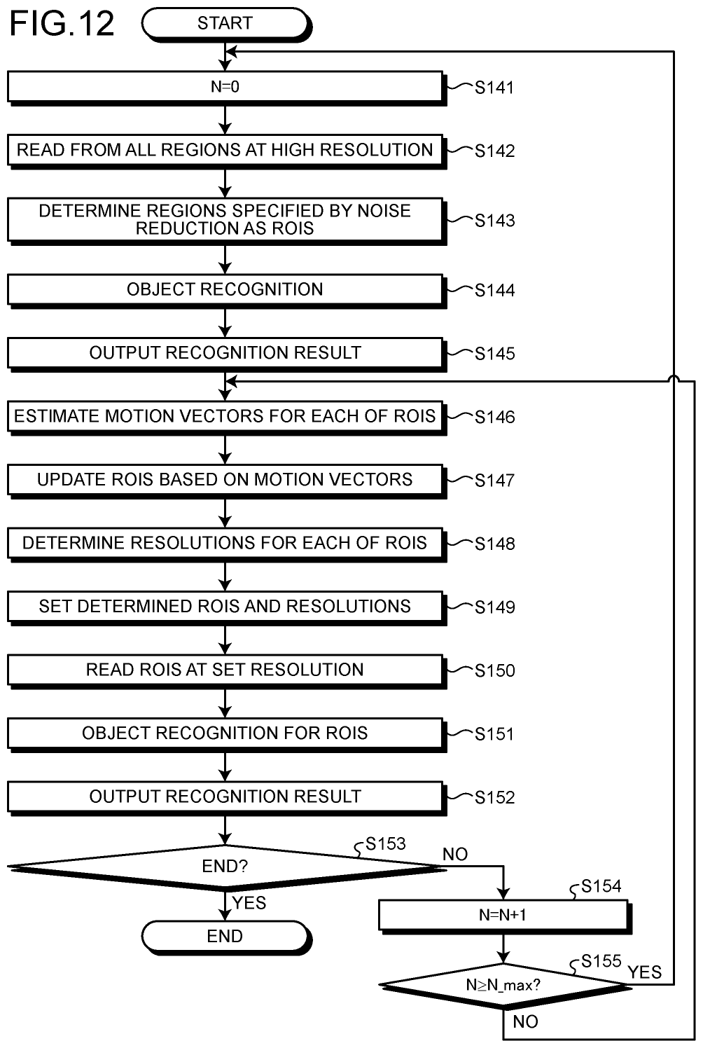

FIG. 12 is a flowchart illustrating a schematic operation of a recognition system according to the third operation example of the present embodiment. As illustrated in FIG. 12, in this operation, the variable N is reset to 0 (N=0) (step S141) and the key frame is read from the image sensor 101 (step S142) according to the same processing as the processing explained above with reference to steps S121 to S122 in FIG. 11. The key frame read in step S142 is subjected to the predetermined processing such as the noise reduction and the white balance adjustment in the signal processing unit 103 and, thereafter, input to the recognition unit 120 via the predetermined network such as the communication network 41.

In this operation example, the control unit 102 of the imaging device 100 acquires, from the signal processing unit 103, information concerning regions specified in the noise reduction processing executed by the signal processing unit 103 on the key frame read in step S142 and determines the acquired regions as ROIs (step S143). That is, in this operation example, the ROIs are determined in the imaging device 100. However, when the noise reduction is executed on the outside of the imaging device 100, the control unit 102 acquires information concerning ROIs determined on the outside. The information concerning the ROIs determined in this way is input to the recognition unit 120 together with the key frame read in step S142.

The recognition unit 120 executes recognition processing on the key frame among the data input from the imaging device 100 in the same manner as steps S123 and S124 in FIG. 11 (step S144) and outputs a result of the recognition processing to the action planning unit 62, the operation control unit 63, and the like (see FIG. 1) (step S145).

Subsequently, the recognition unit 120 estimates motion vectors of the ROIs (or images of objects included in the ROIs) based on the information concerning the ROIs input together with the key frames from the imaging device 100 (step S146) and updates positions and sizes of the ROIs with the estimated motion vectors (step S147). Note that, in estimating the motion vectors, the motion vectors of the ROIs (or images of objects included in the ROIs) may be estimated using the current frame and one or more preceding frames as in step S126 in FIG. 11.

Thereafter, the recognition system executes the same operations as steps S128 to S135 in FIG. 11 (steps S148 to S155).

2.4.4 Fourth Operation Example

In a fourth operation example, a case is explained in which distances to objects are detected by another sensor (hereinafter, referred to as distance measuring sensor) such as the radar 52, the LiDAR 53, or the ultrasonic sensor 54 and resolutions of the ROIs is determined based on the detected distances. Note that, in the following description, the same operations as any one of the operation examples explained above are cited to omit redundant explanation.

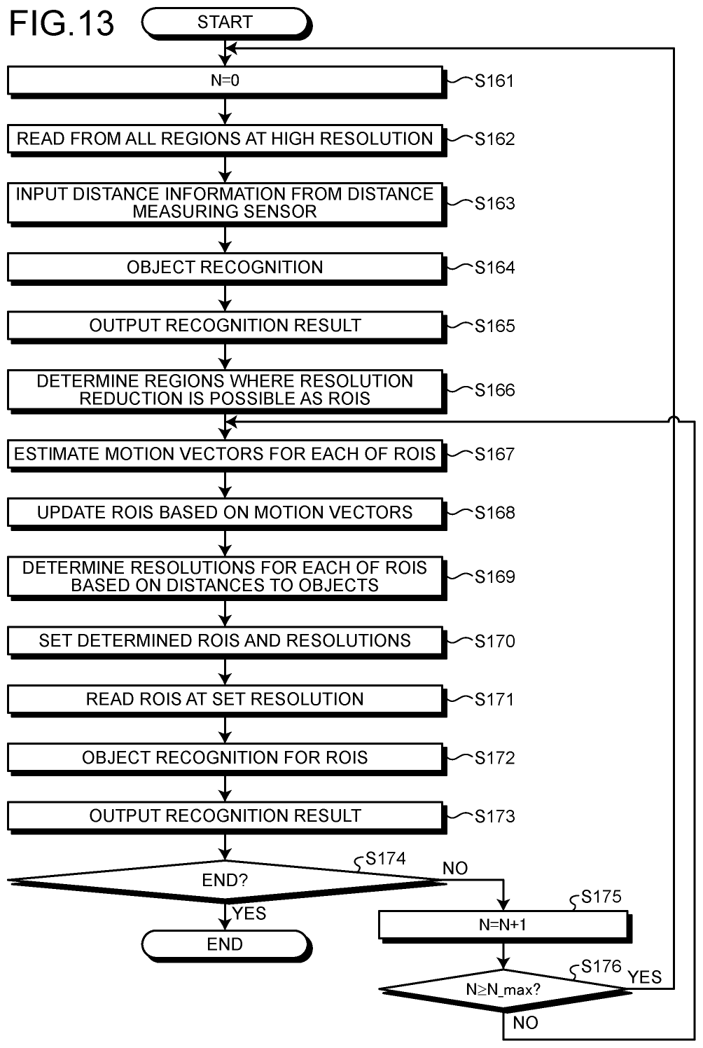

FIG. 13 is a flowchart illustrating a schematic operation of a recognition system according to the fourth operation example of the present embodiment. As illustrated in FIG. 13, in this operation, the variable N is reset to 0 (N=0) (step S161) and the key frame is read from the image sensor 101 (step S162) according to the same processing as the processing explained above with reference to steps S121 to S124 in FIG. 11. The key frame read in step S162 is subjected to the predetermined processing such as the noise reduction and the white balance adjustment in the signal processing unit 103 and, thereafter, input to the recognition unit 120 via the predetermined network such as the communication network 41.

In this operation example, distance information to an object acquired by a distance measuring sensor in synchronization with or at the same timing as acquisition of the key frame by the imaging device 100 (the camera 51) is input to the recognition unit 120 via the predetermined network such as the communication network 41 (step S163). Note that the key frame acquired by the imaging device 100 and the distance information acquired by the distance measuring sensor may be once input to the sensor fusion unit 72 (see FIG. 1), subjected to the sensor fusion processing and, thereafter, input to the recognition unit 120.

The recognition unit 120 executes recognition processing on the key frame among the data input from the imaging device 100 as in steps S123 and S124 in FIG. 11 (step S164) and outputs a result of the recognition processing to the action planning unit 62, the operation control unit 63, and the like (see FIG. 1) (step S165).

Subsequently, as in steps S123 to S168 in FIG. 11, the recognition unit 120 determines, as ROIs, regions where resolution reduction is possible (step S166) and updates positions and sizes of the ROIs based on motion vectors estimated for each of the ROIs (steps S167 to S168).

Subsequently, the recognition unit 120 determines, based on the distances to objects input together with the key frame, resolutions at the time when image data is read from regions on the image sensor 101 corresponding to the ROIs (step S169).

Thereafter, the recognition system executes the operations as steps S129 to S135 in FIG. 11 (steps S170 to S176).

2.5 About Distortion Correction

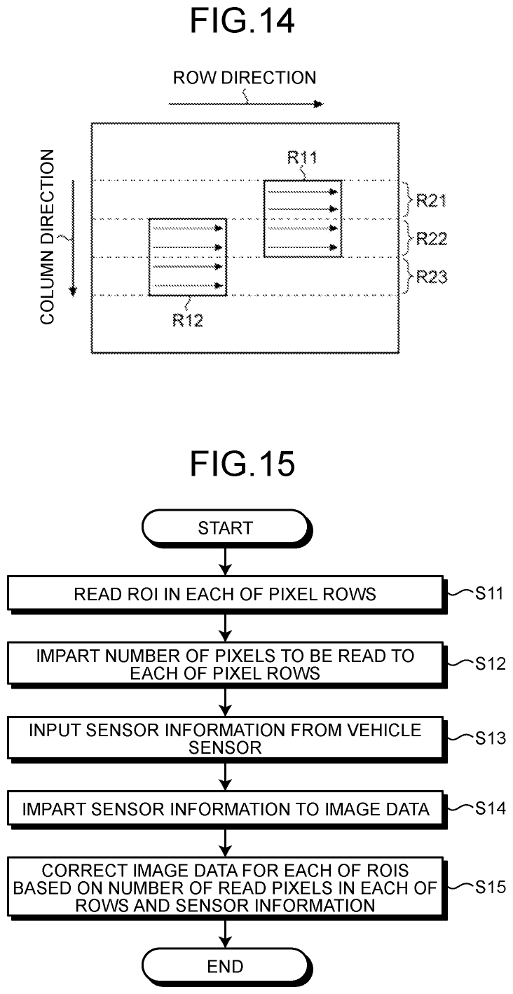

In the operation examples explained above, when a reading scheme for image data in the image sensor 101 is a so-called rolling shutter scheme for sequentially reading pixel signals for each of pixel rows and generating one image data, a reading time changes between a row in which two or more ROIs overlap and a row in which two or more ROIs do not overlap in a row direction. For example, as illustrated in FIG. 14, when two regions R11 and R12 partially overlap each other in the row direction, a difference occurs in a sweep time of the pixel signals read for each of the rows to the signal processing unit 103 between regions R21 and R23 in which the two regions R11 and R12 have no overlap and a region R22 in which the two regions R11 and R12 have overlap in the row direction. That is, in rows of the regions R22 having the overlap, since the number of pixel signals to be output to the signal processing unit 103 is larger compared with rows of the regions R21 and R23 having no overlap, it takes a longer time to sweep. As a result, a difference occurs in an inter-line delay time between the region R22 having the overlap and the regions R21 and R23 having no overlap. Consequently, distortion can occur image data read for each of the ROIs.

In the rolling shutter scheme, when a posture of the imaging device 100 changes to a non-negligible degree during the reading of the image data, distortion can occur in the image data read for each of ROIs because of the posture change.

Therefore, in the present embodiment, the distortion of the image data caused by the factors or the like explained above is corrected based on the number of pixels to be read in the rows (hereinafter referred to as number of read pixels) and the sensor information input from the vehicle sensor 27 such as the IMU. FIG. 15 is a flowchart illustrating an example of a distortion correction operation according to the present embodiment.

As illustrated in FIG. 15, in the distortion correction operation according to the present embodiment, first, image data is read for each of pixel rows from ROIs in regions where the ROIs are present in the row direction in the pixel array unit of the image sensor 101 (step S11). For the read image data of the pixel rows (hereinafter referred to as row data), for example, the number of read pixels for each of the pixel rows is provided as metadata in the signal processing unit 103 (step S12).

Sensor information is input to the imaging device 100 from the vehicle sensor 27 during a read period in step S11 (step S13). The sensor information may be, for example, sensor information detected by a speed sensor, an acceleration sensor, and an angular velocity sensor (gyro sensor) included in the vehicle sensor 27 and the IMU obtained by integrating the sensors. The input sensor information is given as, for example, metadata for image data of one frame for each of the ROIs in the signal processing unit 103 (step S14).

As described above, the image data to which the number of read pixels for each of the pixel rows and the sensor information for each of the frames are imparted is input to the recognition unit 120 via the predetermined network. The recognition unit 120 corrects, for the input image data, distortion that occurs in the image data of the ROIs based on a distortion amount based on the time difference between the rows calculated from the number of read pixels for each of the pixel rows and a distortion amount calculated from the sensor information (step S15).

2.6 Action and Effects

As explained above, according to the present embodiment, since the image data is read at the resolution designated for each of the ROIs, it is possible to reduce traffic from the imaging device 100 to the recognition unit 120 and it is possible to omit redundant processing of reducing resolution. Consequently, it is possible to suppress redundancy of a time required for recognition processing.

According to the present embodiment, since the reading operation is executed targeting the regions set as the ROIs by the recognition unit 120, the data amount of the image data read from the image sensor 101 can be further reduced. Consequently, it is also possible to further reduce traffic from the imaging device 100 to the recognition unit 120.

2.7 Modification

Here, several modifications of the first embodiment explained above are explained. Note that components, operations, and effects not specifically referred to in the following explanation may be the same as those in the embodiment explained above.

2.7.1 First Modification

In the embodiment explained above, the case is explained in which the regions where the objects to be recognized are present are set as the ROIs and the resolutions at the time of reading are set for each of the ROIs. In contrast, in the first modification, a case is explained in which a vanishing point in image data is specified and resolution at the time of reading is set according to a region based on the vanishing point.

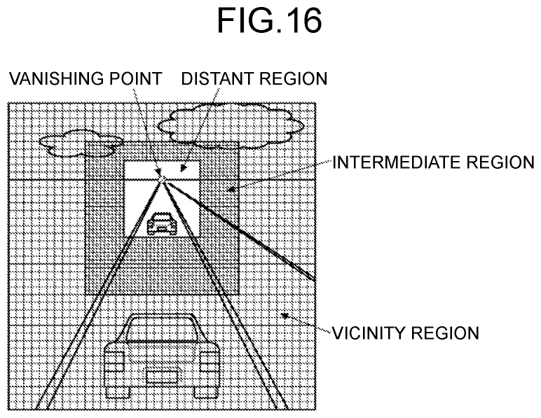

FIG. 16 is a diagram for explaining the resolution set for each of regions in the first modification. As illustrated in FIG. 16, in the present embodiment, for example, the recognition unit 120 specifies a vanishing point in input image data. A position of the vanishing point may be calculated, for example, from a road shape, a white line on a road, or the like according to a general calculation method. At that time, a learned model may be used.

When the position of the vanishing point is specified in this way, the recognition unit 120 segments the image data into two or more regions based on the vanishing point. In an example illustrated in FIG. 16, the recognition unit 120 segments the image data to set a region including the vanishing point as a distant region, set a region surrounding the distant region as an intermediate region, and set a region further surrounding the intermediate region as a vicinity region. Then, the recognition unit 120 determines resolution at the time of reading the distant region as high resolution having the highest resolution, determines resolution at the time of reading the near region as low resolution having the lowest resolution, and determines resolution at the time of reading the intermediate region as intermediate resolution in the middle between the high resolution and the low resolution. The resolutions determined for the regions are input to the imaging device 100 together with information for specifying the regions. The imaging device 100 controls reading of image data from the image sensor 101 based on the input resolutions of each of the regions.

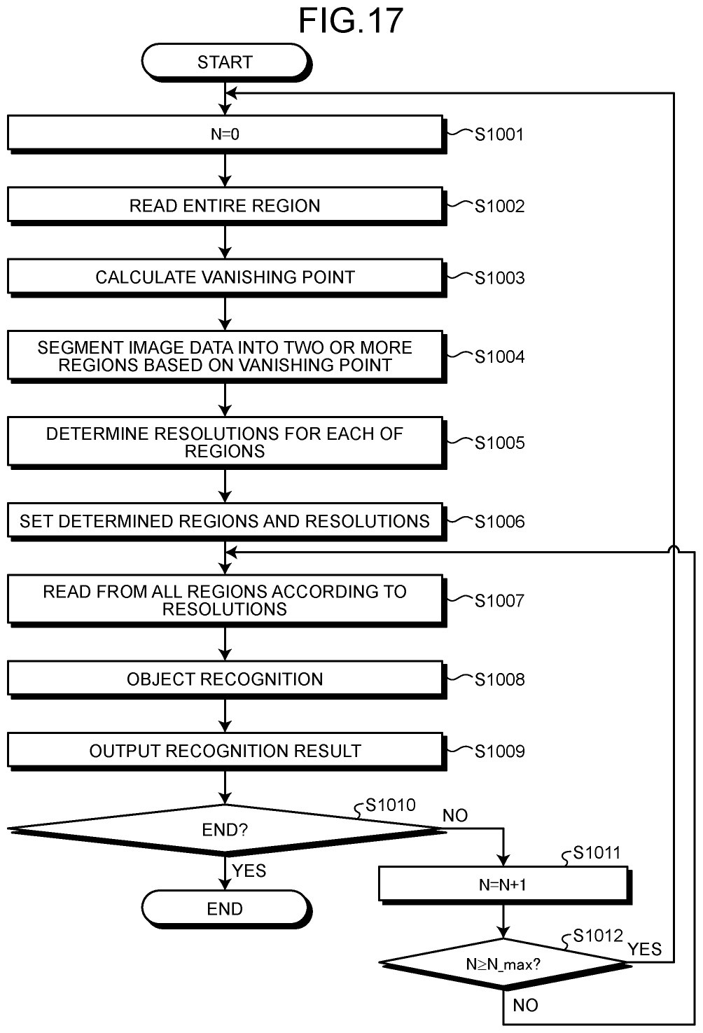

FIG. 17 is a flowchart illustrating a schematic operation of the recognition system according to the present modification. As illustrated in FIG. 17, in this operation, the variable N is reset to 0 (N=0) (step S1001) and image data is read from the image sensor 101 (step S1002) according to the same process as the process explained above with reference to steps S121 and S122 in FIG. 11. Note that the image data read in step S1002 may be high-resolution image data or may be low-resolution image data obtained by thinning, binning, or the like. Furthermore, the image data read in step S1002 is subjected to the predetermined processing such as the noise reduction and the white balance adjustment in the signal processing unit 103 and, thereafter, input to the recognition unit 120 via the predetermined network such as the communication network 41.

The recognition unit 120 calculates a vanishing point for the image data input from the imaging device 100 (step S1003), and segments the image data into two or more regions (see FIG. 16) based on the calculated vanishing point (step S1004). The segmentation of the image data may be executed, for example, according to a rule created in advance. For example, straight lines from the vanishing point to corners of the image data may be equally divided into M (M is an integer equal to or larger than 1) and lines connecting points for equally dividing the straight lines into M may be set as boundary lines to segment the image data into a plurality of regions.

Then, the recognition unit 120 determines resolutions for each of the segmented regions (step S1005). The determination of the resolutions for each of the regions may be executed according to a rule created in advance like the segmentation of the image data. For example, a region including the vanishing point (the distant region in FIG. 16) may be determined as having the highest resolution and the resolutions for each of the regions may be determined such that the resolutions decrease in the order from the region closest from the vanishing point.

Subsequently, the recognition unit 120 sets the regions and the resolutions determined as explained above in the imaging device 100 (step S1006). In contrast, the control unit 102 of the imaging device 100 executes, for each of the set regions, reading from each the regions at the resolutions set for each of the regions (step S1007). The image data read from the regions is subjected to the predetermined processing such as the noise reduction and the white balance adjustment in the signal processing unit 103 and, thereafter, input to the recognition unit 120 via the predetermined network. At that time, since the image data to be transferred has different resolutions for each of the regions, traffic at the time of transfer is reduced.

Subsequently, the recognition unit 120 executes recognition processing on the input image data for each of the regions (step S1008) and outputs a result of the recognition processing to the action planning unit 62, the operation control unit 63, and the like (see FIG. 1) (step S1009). In the recognition processing in step S131, since the region in which an object present nearby is imaged is image data having lower resolution, it is possible to reduce a recognition processing time by reducing a calculation amount. Since processing of reducing excessively high resolution of image data is also omitted, the recognition processing time can be further shortened.

Thereafter, the recognition system determines whether to end this operation (step S1010) and, when determining to end this operation (YES in step S1010), ends this operation. On the other hand, when the recognition system determines not to end this operation (NO in step S1010), the control unit 102 increments the variable N by 1 (N=N+1) (step S1011). Subsequently, the control unit 102 determines whether the incremented variable N has reached the preset maximum value N_max (step S1012).

When the control unit 102 determines that the variable N has reached the maximum value N_max (YES in step S1012), this operation returns to step S1001 and the subsequent operations are executed. On the other hand, when the control unit 102 determines that the variable N has not reached the maximum value N_max (NO in step S1012), this operation returns to step S1007 and the subsequent operations are executed.

2.7.2 Second Modification

In a second modification, a case is explained in which a horizon in image data is specified instead of a vanishing point and resolution at the time of reading is set according to a region based on the horizon.

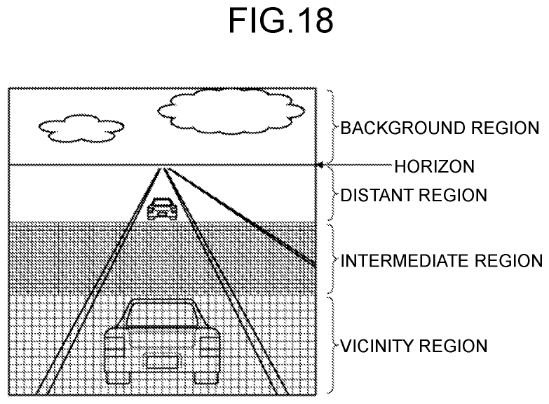

FIG. 18 is a diagram for explaining resolutions set for each of regions in the second modification. As illustrated in FIG. 18, in the present embodiment, for example, the recognition unit 120 specifies a background region in input image data. As explained above, the background region may be a region in a wide range located in the distance such as sky, mountains, plains, or the sea. The background region may be specified based on distance information input from the external recognition sensor 25 such as the radar 52, the LiDAR 53, or the ultrasonic sensor 54 besides the image analysis in the recognition unit 120. Then, the recognition unit 120 determines a position of the horizon in the image data based on the specified background region.

When the position of the horizon is specified in this way, the recognition unit 120 segments the image data into three or more regions in the vertical direction based on the horizon. One of the three or more regions may be the background region. In an example illustrated in FIG. 18, the recognition unit 120 segments the image data to set a region above the horizon as a background region, set an upper part of a region below the horizon as a distant region, set an upper part of a region below the distant region as an intermediate region, and set a region below the intermediate region as a vicinity region. However, not only this, but the background region and the distant region may be set as one distant region or one background region. In that case, the recognition unit 120 segments the image data into two or more regions in the vertical direction. Then, as in the first modification, the recognition unit 120 determines resolution at the time of reading the distant region as high resolution having the highest resolution, determines resolution at the time of reading the vicinity region as low resolution having the lowest resolution, and determines resolution at the time of reading the intermediate region as intermediate resolution in the middle between the high resolution and the low resolution. The resolutions determined for the regions are input to the imaging device 100 together with information for specifying the regions. The imaging device 100 controls reading of image data from the image sensor 101 based on the input resolutions of each of the regions.

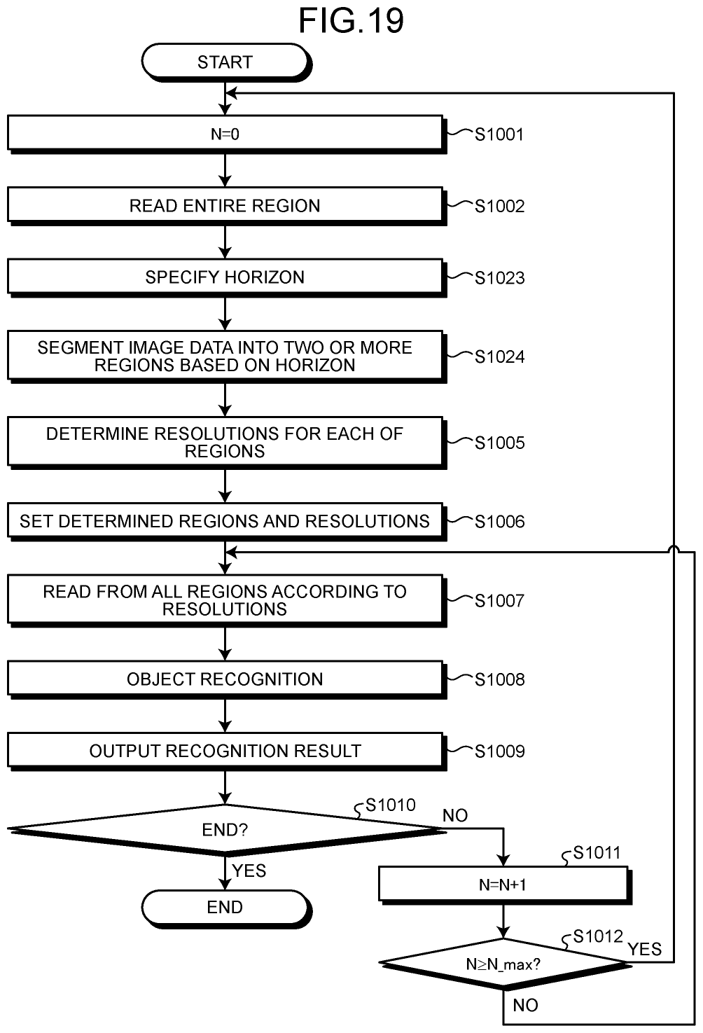

FIG. 19 is a flowchart illustrating a schematic operation of the recognition system according to the present modification. As illustrated in FIG. 19, in this operation, in the same operation as the operation according to the first modification explained above with reference to FIG. 17, steps S1003 and S1004 are replaced with step S1023 for specifying a horizon and step S1024 for segmenting image data into two or more regions based on the horizon. The other operations may be the same as the operations explained with reference to FIG. 17. Therefore, here, detailed explanation of the operations is omitted.

### 3. Second Embodiment

Subsequently, a second embodiment of the present disclosure is explained in detail with reference to the drawings. The present embodiment illustrates a case in which traffic in transferring image data acquired by an imaging device that acquires image data formed by pixels in which a luminance change has occurred (hereinafter also referred to as differential image) in addition to a color image or a monochrome image is reduced. Note that, in the following explanation, the same components and operations as those in the embodiment explained above are cited to omit redundant explanation.

3.1 Schematic Configuration Example of a Recognition System

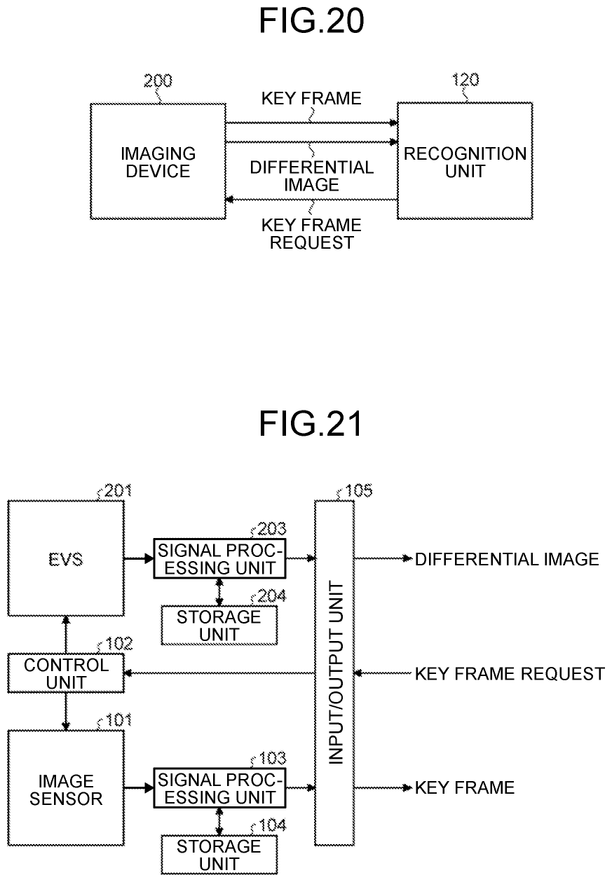

FIG. 20 is a block diagram illustrating an overview of a recognition system according to the present embodiment. As illustrated in FIG. 20, the recognition system includes an imaging device 200 and the recognition unit 120.

The imaging device 200 is equivalent to, for example, the camera 51 and the in-vehicle sensor 26 explained above with reference to FIG. 1, and generates and outputs a color image or a monochrome image (a key frame) of an entire imaging region and a differential image including a pixel in which a luminance change has occurred. These image data are input to the recognition unit 120 via, for example, the predetermined network such as the communication network 41 explained above with reference to FIG. 1.

The recognition unit 120 is equivalent to, for example, the recognition unit 73 or the like explained above with reference to FIG. 1 and reconfigures an entire image of a current frame based on the key frame and/or reconfigured one or more image data (hereinafter collectively referred to as entire image) and the differential image input from the imaging device 200. The recognition unit 120 detects an object, a background, and the like included in an image by executing recognition processing on the key frame or the reconfigured entire image.

For example, for each predetermined number of frames or when determining that the entire image based on the key frame and the differential image cannot be reconfigured, the recognition unit 120 transmits a key frame request for requesting a key frame to the imaging device 200. In contrast, the imaging device 200 transmits image data read from the image sensor 101 to the recognition unit 120 as a key frame.

3.2 Schematic Configuration Example of an Imaging Device

FIG. 21 is a block diagram illustrating a schematic configuration example of the imaging device according to the present embodiment. As illustrated in FIG. 21, the imaging device 200 includes an EVS (Event Vision Sensor) 201, a signal processing unit 203, and a storage unit 204 in addition to the same components as the components of the imaging device 100 explained with reference to FIG. 4 in the first embodiment. Note that the image sensor 101 and the EVS 201 may be provided on the same chip. At that time, the image sensor 101 and the EVS 201 may share the same photoelectric conversion unit. One or more of the EVS 201, the control unit 102, the signal processing units 103 and 203, the storage units 104 and 204, and the input/output unit 105 may be provided on a chip on which the image sensor 101 is provided.

The EVS 201 outputs address information for identifying a pixel in which a luminance change (also referred to as event) has occurred. The EVS 201 may be a synchronous EVS or may be an asynchronous EVS. Note that a time stamp for specifying time when the event occurs may be imparted to the address information.

The signal processing unit 203 generates, based on the address information output from the EVS 201, a differential image including the pixel in which the event has occurred. For example, the signal processing unit 203 may aggregate address information output from the EVS 201 during one frame period in the storage unit 204 to generate a differential image including the pixel in which the event has occurred. The signal processing unit 203 may execute the predetermined signal processing such as the noise reduction on the differential image generated in the storage unit 204.

The input/output unit 105 transmits the key frame input via the signal processing unit 103 and the differential image input from the signal processing unit 203 to the recognition unit 120 via the predetermined network (for example, the communication network 41).

The control unit 102 controls operations of the image sensor 101 and the EVS 201. When the key frame request is input via the input/output unit 105, the control unit 102 drives the image sensor 101 and transmits image data read by the image sensor 101 to the recognition unit 120 as the key frame.

3.3 About Suppression of Redundancy of a Time Required for Recognition Processing

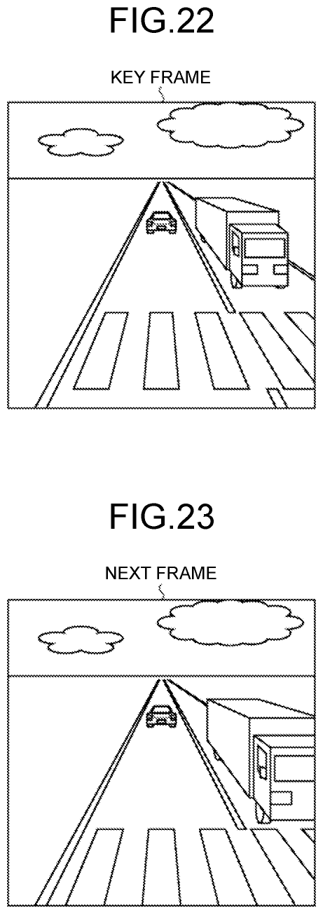

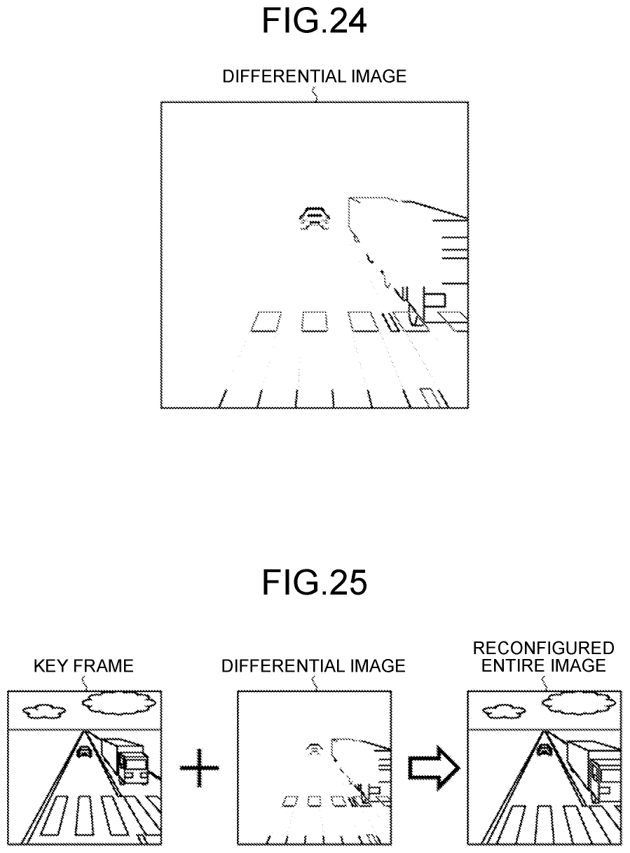

Subsequently, how to reduce an amount of data transferred from the imaging device 200 to the recognition unit 120 in the present embodiment is explained. FIG. 22 is a diagram illustrating an example of image data acquired in a certain frame period in the present embodiment. FIG. 23 is a diagram illustrating an example of image data acquired in the next frame period when the present embodiment is not applied, and FIG. 24 is a diagram illustrating an example of a differential image acquired in the next frame period when the present embodiment is applied. FIG. 25 is a diagram for describing the reconfiguration of an entire image according to the present embodiment.

As illustrated in FIG. 22 and FIG. 23, when the present embodiment is not applied, image data after one frame cycle is acquired in a frame period next to the certain frame period. This image data has a data amount equivalent to that of the key frame. Therefore, when the image data acquired in the next frame period is directly transferred to the recognition unit 120, it is likely that traffic increases and a recognition processing time becomes redundant.

On the other hand, as illustrated in FIG. 22 and FIG. 24, when the present embodiment is applied, in the frame period next to the certain frame period, a differential image including a pixel in which an event is detected in one frame period is acquired. Since the differential image includes only the pixel in which the event is detected and is a monochrome image having no color information, a data amount of the differential image is very small as compared with the key frame. Therefore, it is possible to greatly reduce traffic in the next frame period.

As illustrated in FIG. 25, the recognition unit 120 reconfigures an entire image of a current frame based on a key frame input from the imaging device 200 during the previous frame period and/or reconfigured one or more entire images and a differential image input in a current frame period. For example, the recognition unit 120 specifies a region of an object in the current frame in the entire image based on edge information of the object extracted from the differential image and complements texture of the specified region based on texture of the object in the entire image. Consequently, the entire image of the current frame is reconfigured. In the following explanation, the reconfigured entire image is referred to as reconfigured image as well.

3.4 Operation Examples

Subsequently, several operation examples of the recognition system according to the present embodiment are explained.

3.4.1 First Operation Example

In a first operation example, a case is explained in which a key frame is read from the image sensor 101 at a rate of once in several frames and a differential image is read from the EVS 201 in the other frames.

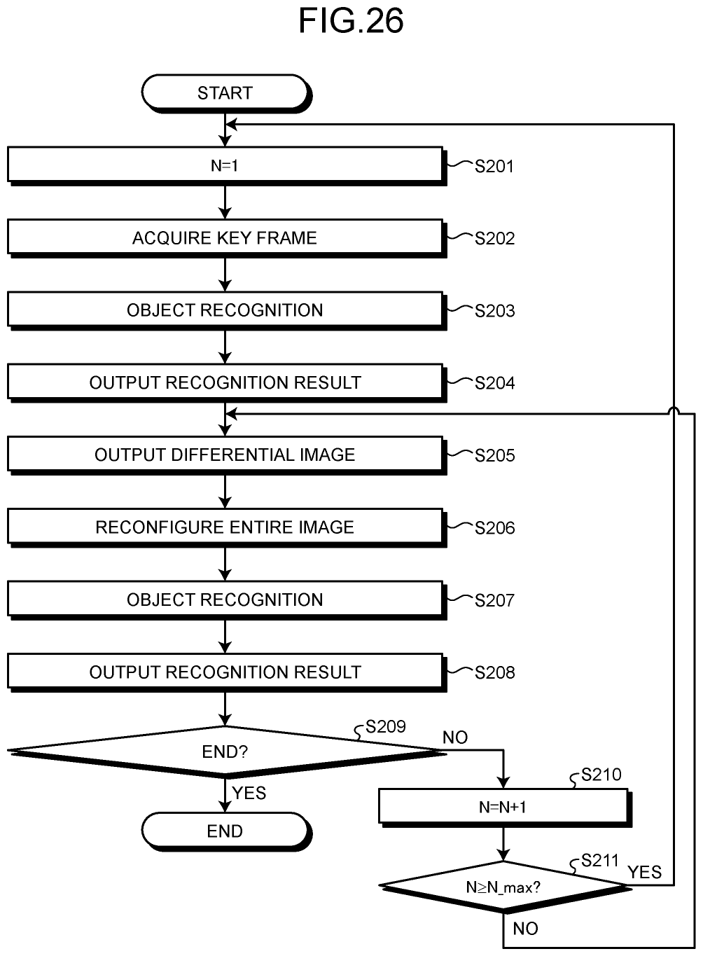

FIG. 26 is a flowchart illustrating a schematic operation of a recognition system according to the first operation example of the present embodiment. As illustrated in FIG. 26, in this operation, first, the control unit 102 of the imaging device 200 resets the variable N for managing a frame period for acquiring a key frame to 0 (N=0) (step S201).

Subsequently, the control unit 102 executes reading of a key frame from the image sensor 101 (step S202). The key frame to be read may be image data read from the entire region of the pixel array unit. Reading at high resolution may be normal reading not involving the thinning and the binning.

The key frame read in step S202 is subjected to the predetermined processing such as the noise reduction and the white balance adjustment in the signal processing unit 103, and, thereafter, input to the recognition unit 120 via the predetermined network such as the communication network 41. On the other hand, the recognition unit 120 executes recognition processing on the input key frame (step S203), and outputs a result of the recognition processing to the action planning unit 62, the operation control unit 63, and the like (see FIG. 1) (step S204).

Subsequently, the control unit 102 outputs a differential image generated by the EVS 201 during a frame period next to the frame period in step S202 to the recognition unit 120 (step S205). At that time, since the differential image to be transferred is image data having a smaller data amount than image data of the entire region, the traffic at the time of transfer is reduced.

When the differential image is input, the recognition unit 120 reconfigures an entire image of a current frame using a previously input key frame and/or one or more entire images reconfigured previously and the differential image input in step S205 (step S206).

Subsequently, the recognition unit 120 executes recognition processing on the reconfigured entire image (step S207) and outputs a result the recognition processing to the action planning unit 62, the operation control unit 63, and the like (see FIG. 1) (step S208). In the recognition processing in step S207, it is possible to execute the same processing as the recognition processing for the key frame in step S203.

Thereafter, the recognition system determines whether to end this operation (step S209) and, when determining to end this operation (YES in step S209), ends this operation. On the other hand, when the recognition system determines not to end this operation (NO in step S209), the control unit 102 increments the variable N by 1 (N=N+1) (step S210). Subsequently, the control unit 102 determines whether the incremented variable N has reached the preset maximum value N_max (step S211).

when the control unit 102 determines that the variable N has reached the maximum value N_max (YES in step S211), this operation returns to step S201 and the subsequent operations are executed. On the other hand, when the control unit 102 determines that the variable N has not reached the maximum value N_max (NO in step S211), this operation returns to step S205, and the subsequent operations are executed.

3.4.2 Second Operation Example

In a second operation example, a case is explained in which an entire image cannot be reconfigured using a differential image, that is, when a reconfiguration limit has reached, a key frame is read again from the image sensor 101. Note that, in the following explanation, the same operations as the operation examples explained above are cited to omit redundant explanation.

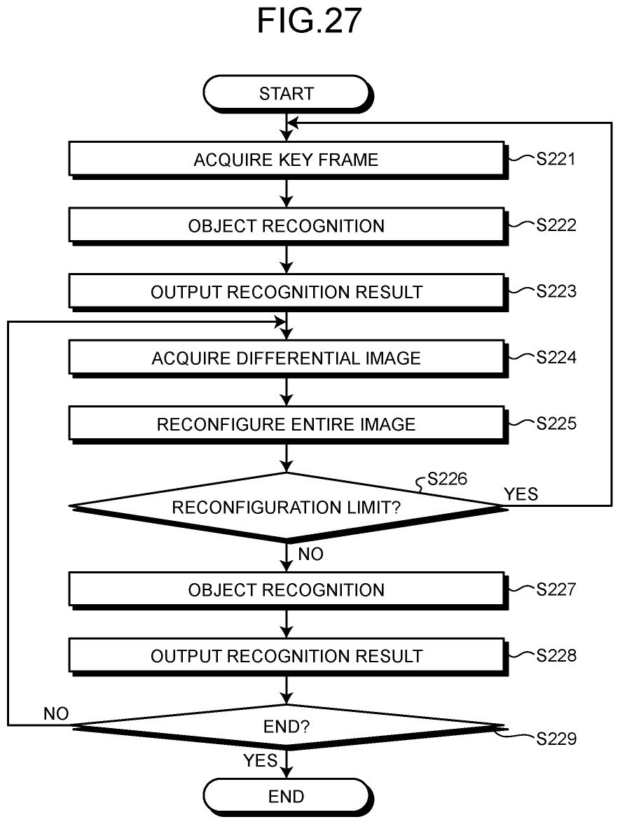

FIG. 27 is a flowchart illustrating a schematic operation of a recognition system according to the second operation example of the present embodiment. As illustrated in FIG. 27, in this operation, first, as in steps S202 to S206 in FIG. 26, recognition processing for a key frame and reconfiguration of an entire image using a differential image are executed (steps S221 to S225). However, in this operation example, when the entire image is not successfully reconfigured using the differential image in step S225, that is, when the reconfiguration limit has reached (YES in step S226), this operation returns to step S221, the key frame is acquired again, and the subsequent operations are executed.

On the other hand, when the entire image is successfully reconfigured (NO in step S226), as in steps S207 to S208 in FIG. 26, the recognition unit 120 executes recognition processing on the reconfigured entire image (step S227) and outputs a result of the recognition processing to the action planning unit 62, the operation control unit 63, and the like (see FIG. 1) (step S228).

Thereafter, the recognition system determines whether to end this operation (step S229) and, when determining to end this operation (YES in step S229), ends this operation. On the other hand, when the recognition system determines not to end this operation (NO in step S229), this operation returns to step S224 and the subsequent operations are executed.

3.4.3 Third Operation Example

In the first and second operation examples explained above, the case is illustrated in which the key frame and the differential image are acquired using the entire effective pixel region of the pixel array unit as one region. In contrast, in a third operation example, a case is explained in which the effective pixel region of the pixel array unit is divided into a plurality of regions (hereinafter referred to as partial regions) and key frames (hereinafter referred to as partial key frames) and differential images (hereinafter referred to as partial differential images) are acquired from the respective regions.

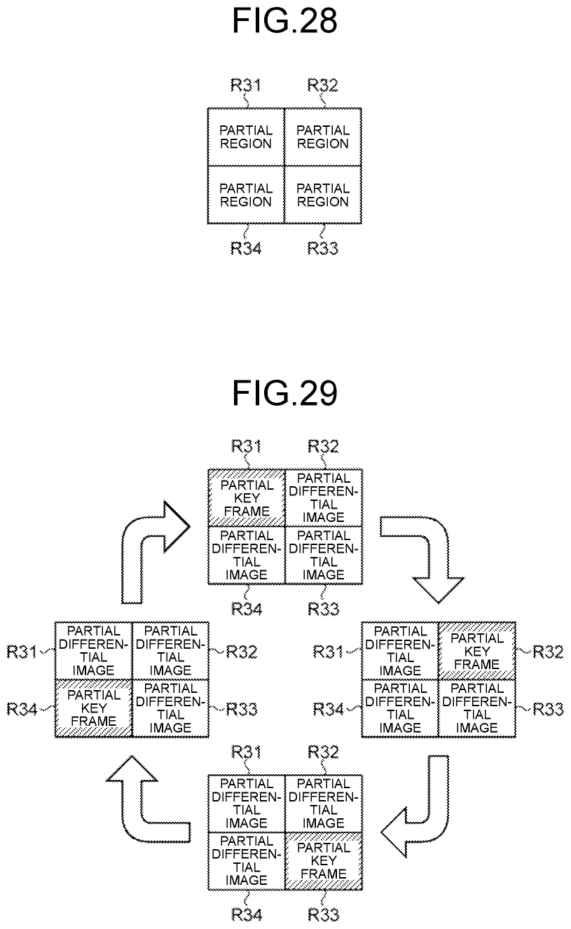

FIG. 28 is a schematic diagram for explaining partial regions according to the third operation example of the present embodiment. As illustrated in FIG. 28, in this operation example, the effective pixel region in the pixel array unit of each of the image sensor 101 and the EVS 201 is divided into a plurality of (four in 2×2 in this example) partial regions R31 to R34. For example, the first or second operation example explained above may be applied to read operations of partial key frames and partial differential images for the partial regions R31 to R34. At that time, the read operations for the partial regions R31 to R34 may be independent of one another. However, from the partial regions R31 to R34, partial key frames or partial differential images are output in a synchronized frame cycle.

The recognition unit 120 to which the partial key frames and the partial differential images read from the partial regions R31 to R34 are input reconfigures partial entire images of current frames of the partial regions R31 to R34 using previous partial key frames or entire images (hereinafter referred to as partial entire images) of the partial regions R31 to R34. Then, the recognition unit 120 combines the reconfigured partial entire images of the partial regions R31 to R34 to generate an entire image of the entire region and executes recognition processing for the entire image.

3.4.4 Fourth Operation Example

In the third operation example explained above, the case is illustrated in which the read operation for the partial regions R31 to R34 is independent from one another. In contrast, in a fourth operation example, a case is explained in which the read operations for the partial regions R31 to R34 are synchronized.

FIG. 29 is a diagram for explaining a read operation according to the fourth operation example of the present embodiment. As illustrated in FIG. 29, in the fourth operation example, the imaging device 200 operates such that partial key frames are read from the respective partial regions R31 to R34 in order without overlapping. Consequently, it is possible to prevent two or more partial key frames from being read in a certain frame period. Therefore, it is possible to suppress traffic at the time of transfer from temporarily increasing.

Note that, as in the third operation example, the recognition unit 120 reconfigures partial entire images of current frames of the partial regions R31 to R34 using the previous partial key frames or entire images (hereinafter referred to as partial entire images) of the partial regions R31 to R34 and combines the reconfigured partial entire images of the partial regions R31 to R34 to generate an entire image of the entire region. Then, the recognition unit 120 executes recognition processing for the combined entire image.

3.4.4.1 Modification of the Fourth Operation Example

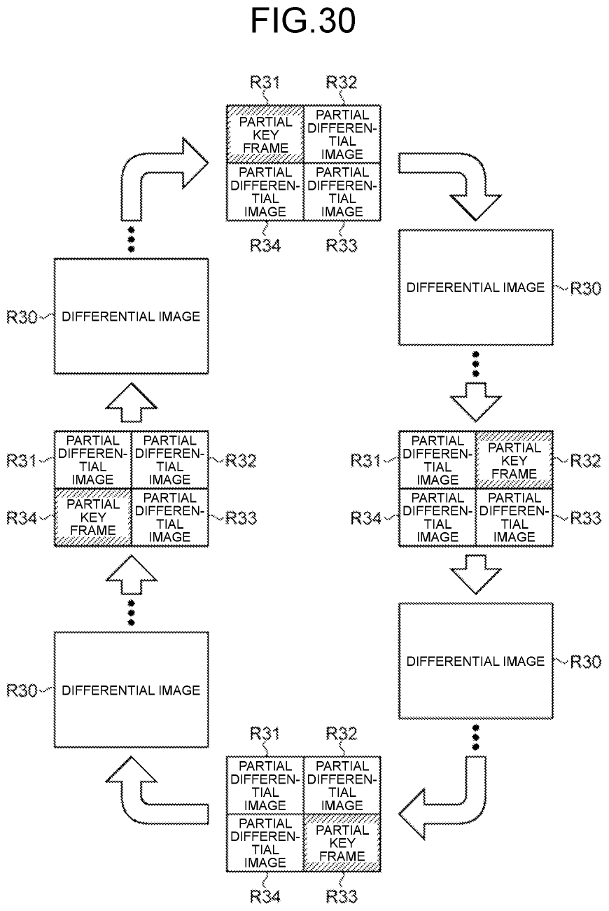

In the fourth operation example explained above, the case is explained in which the partial key frame is read from one of the plurality of partial regions R31 to R34 in the frame periods. However, the present invention is not limited to this. For example, as illustrated in FIG. 30, when the partial key frame is read from any one of the partial regions R31 to R34, in the next several frames, differential images may be read from all the partial regions R31 to R34, that is, the entire effective pixel region R30.

3.5 Distortion Correction

Subsequently, correction of relative distortion that occurs between image data (for example, a key frame) read from the image sensor 101 and image data (for example, a differential image) read from the EVS 201 is explained.

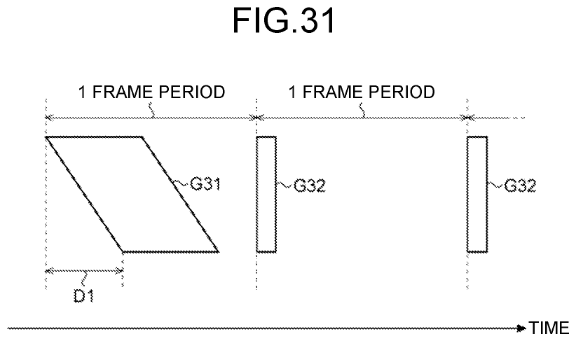

FIG. 31 is a schematic diagram for explaining distortion correction according to the present embodiment. In the operation examples explained above, when the reading scheme for image data in the image sensor 101 is the rolling shutter scheme, a time difference D1 occurs in reading timing between the uppermost pixel row and the lowermost pixel row in the column direction. Therefore, distortion called rolling shutter distortion occurs in image data G31 to be read. In contrast, in the EVS 201, since events are detected in individual pixels in the same operation as the so-called global shutter scheme of simultaneous driving of all pixels, distortion does not occur in image data G32 output from the EVS 201 or is negligibly small in recognition processing by the recognition unit 120.

Therefore, in the present embodiment, the distortion of the image data caused by the factors or the like explained above is corrected based on the number of pixels to be read in the rows (hereinafter referred to as number of read pixels) and the sensor information input from the vehicle sensor 27 such as the IMU. This distortion correction operation may be the same as the distortion correction operation explained with reference to FIG. 15 in the first embodiment.

By executing such distortion correction, it is possible to correct relative distortion that occurs between image data read from the image sensor 101 and image data read from the EVS 201. Therefore, it is possible to improve accuracy of an entire image to be reconfigured. As a result, it is possible to improve accuracy of the recognition processing. Since it is possible to improve accuracy of a key frame and an entire image, it is also possible to relax a reconfiguration limit of the entire image. Consequently, since it is possible to reduce a frequency of reading the key frame, it is possible to reduce a recognition processing time by a reduction of traffic at the time of transfer as a whole.

3.6 Action and Effects

As explained above, according to the present embodiment, since the entire image is reconfigured from the differential image having a small data amount, it is possible to reduce traffic from the imaging device 200 to the recognition unit 120. Consequently, it is possible to suppress redundancy of a time required for recognition processing.

the other components, operations, and effects may be the same as those in the embodiments explained above. Therefore, detailed explanation thereof is omitted here.

### 4. Hardware Configuration

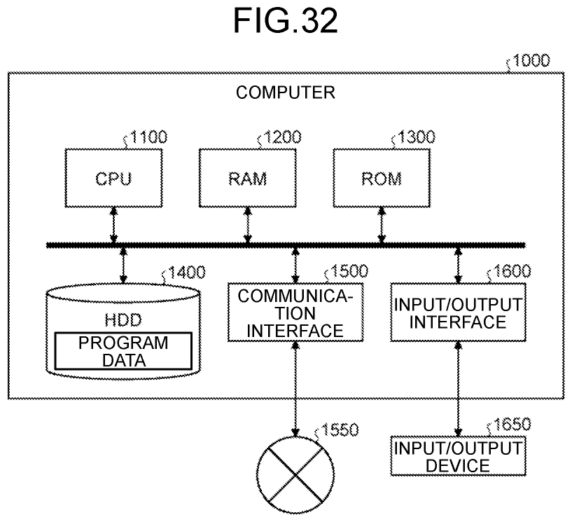

The recognition unit 120 according to the embodiments, the modifications thereof, and the application examples explained above can be realized by, for example, a computer 1000 having a configuration illustrated in FIG. 32. FIG. 32 is a hardware configuration diagram illustrating an example of the computer 1000 that realizes the functions of the information processing device constituting the recognition unit 120. The computer 1000 includes a CPU 1100, a RAM 1200, a ROM (Read Only Memory) 1300, an HDD (Hard Disk Drive) 1400, a communication interface 1500, and an input/output interface 1600. The units of the computer 1000 are connected by a bus 1050.

The CPU 1100 operates based on programs stored in the ROM 1300 or the HDD 1400 and controls the units. For example, the CPU 1100 develops the programs stored in the ROM 1300 or the HDD 1400 in the RAM 1200 and executes processing corresponding to various programs.

The ROM 1300 stores a boot program such as a BIOS (Basic Input Output System) to be executed by the CPU 1100 at a start time of the computer 1000, a program depending on hardware of the computer 1000, and the like.

The HDD 1400 is a computer-readable recording medium that non-transiently records a program to be executed by the CPU 1100, data to be used by such a program, and the like. Specifically, the HDD 1400 is a recording medium that records a projection control program according to the present disclosure, which is an example of program data 1450.

The communication interface 1500 is an interface for the computer 1000 to be connected to an external network 1550 (for example, the Internet). For example, the CPU 1100 receives data from other equipment and transmits data generated by the CPU 1100 to the other equipment via the communication interface 1500.

The input/output interface 1600 is a component including the I/F unit 18 explained above and is an interface for connecting an input/output device 1650 and the computer 1000. For example, the CPU 1100 receives data from an input device such as a keyboard or a mouse via the input/output interface 1600. The CPU 1100 transmits data to an output device such as a display, a speaker, or a printer via the input/output interface 1600. The input/output interface 1600 may function as a media interface that reads a program or the like recorded in a predetermined recording medium (a medium). The medium is, for example, an optical recording medium such as a DVD (Digital Versatile Disc) or a PD (Phase change rewritable Disk), a magneto-optical recording medium such as an MO (Magneto-Optical disk), a tape medium, a magnetic recording medium, or a semiconductor memory.

For example, the CPU 1100 of the computer 1000 executes a program loaded on the RAM 1200 to thereby function as the recognition unit 120 according to the embodiments explained above. A program and the like according to the present disclosure are stored in the HDD 1400. Note that the CPU 1100 reads the program data 1450 from the HDD 1400 and executes the program data. However, as another example, the CPU 1100 may acquire these programs from another device via the external network 1550.

Although the embodiments of the present disclosure are explained above, the technical scope of the present disclosure is not limited to the embodiments explained above per se. Various changes are possible without departing from the gist of the present disclosure. Components in different embodiments and modifications may be combined as appropriate.

The effects in the embodiments described in this specification are only illustrations and are not limited. Other effects may be present.

Note that the present technique can also take the following configurations.

(1)

An imaging device including:
an image sensor configured to acquire image data; and
a control unit that controls the image sensor, wherein
the control unit causes the image sensor to execute second imaging based on one or more imaging regions determined based on image data acquired by causing the image sensor to execute first imaging and resolution determined for each of the imaging regions, and
each of the imaging regions is a partial region of an effective pixel region in the image sensor.
   (2)

The imaging device according to (1), wherein the control unit causes the image sensor to execute the first imaging to acquire the image data at resolution lower than maximum resolution of the image sensor.

(3)

The imaging device according to (1), wherein the control unit controls the image sensor to execute the first imaging in a cycle of once in a predetermined number of frames.

(4)

The imaging device according to (3), wherein the control unit causes the image sensor to execute the second imaging based on the one or more imaging regions determined based on the image data acquired in the first imaging of a frame before a current frame and the resolution.

(5)

The imaging device according to (4), wherein the control unit causes the image sensor to execute the second imaging based on the one or more imaging regions determined based on a result of recognition processing executed on the image data acquired in the first imaging and the resolution.

(6)

The imaging device according to (4), further including a signal processing unit that performs noise reduction for the image data acquired by the image sensor, wherein
the control unit determines the one or more imaging regions based on a region determined in noise reduction executed by the signal processing unit on the image data acquired in the first imaging of the frame before the current frame and causes the image sensor to execute the second imaging based on the one or more imaging regions and the resolution determined for each of the imaging regions.
   (7)

The imaging device according to (4), wherein the control unit causes the image sensor to execute the second imaging based on the one or more imaging regions determined based on the image data acquired by the first imaging and a distance to an object detected by an external distance measuring sensor, and the resolution determined for each of the imaging regions.

(8)

The imaging device according to (4), wherein the control unit causes the image sensor to execute the second imaging based on the one or more imaging regions determined based on a vanishing point in the image data acquired by the first imaging and the resolution determined for each of the imaging regions.

(9)

The imaging device according to (4), wherein the control unit causes the image sensor to execute the second imaging based on the one or more imaging regions determined based on a horizon in the image data acquired by the first imaging and the resolution determined for each of the imaging regions.

(10)

An information processing device including a processing unit that determines the one or more imaging regions and the resolution for each of the imaging regions based on the image data input from the imaging device according to any one of (1) to (9) and sets the determined one or more imaging regions and the resolution in the control unit.

(11)

An imaging system including:
the imaging device according to any one of (1) to (9); and
the information processing device according to (10), wherein
the imaging device and the information processing device are connected via a predetermined network.
   (12)

An imaging method including:
determining, by a processor, the one or more imaging regions and the resolution for each of the imaging regions based on the image data input from the imaging device according to any one of (1) to (9); and
setting, by the processor, the determined one or more imaging regions and the determined resolution in the control unit.
   (13)

An imaging device including:
an image sensor that acquires image data;
an event sensor that detects a luminance change for each of pixels; and
a control unit that controls the image sensor and the event sensor, wherein
the control unit controls the image sensor in response to a request from an information processing device connected via a predetermined network to acquire the image data and, when there is no request from the information processing device, controls the event sensor to generate a differential image including a pixel in which a luminance change is detected.
   (14)

An information processing device including a processing unit that reconfigure image data of a current frame based on the image data and the differential image input from the imaging device according to (13), wherein
the processing unit requests the imaging device to acquire image data by the image sensor.
   (15)

The information processing device according to (14), wherein the processing unit requests the imaging device to acquire the image data by the image sensor at a cycle of once in a predetermined number of frames.

(16)

The information processing device according to (14), wherein the processing unit requests the imaging device to acquire the image data by the image sensor when the image data of the current frame based on the image data and the differential image cannot be reconfigured.

(17)

An imaging device including:
an image sensor that acquires image data;
an event sensor that detects a luminance change for each of pixels;
a control unit that controls the image sensor and the event sensor, wherein
the image sensor acquires image data in each of a plurality of first partial regions obtained by dividing an effective pixel region,
the event sensor acquires a differential image in each of a plurality of second partial regions obtained by dividing the effective pixel region such that each of the second partial regions corresponds to any one of the first partial regions, and
the control unit controls the image sensor such that a first partial region from which image data is read is switched to any one of the plurality of first partial regions for each of frames and controls the event sensor such that a differential image of each of the second partial regions corresponding to the first partial regions from which the image data is not read is generated.
   (18)

The imaging device according to (17), wherein the control unit switches the first partial region from which the image data is read such that a frame in which the image data is not generated is interposed between frames in which the image data is acquired from any of the plurality of first partial regions.

(19)

An imaging system including:
the imaging device according to (13), (17) or (18); and
an information processing device including a processing unit that reconfigures image data of a current frame based on the image data and the differential image input from the imaging device.

### REFERENCE SIGNS LIST

100, 200 IMAGING DEVICE
101 IMAGE SENSOR
102 CONTROL UNIT
103, 203 SIGNAL PROCESSING UNIT
104, 204 STORAGE UNIT
105 INPUT/OUTPUT UNIT
120 RECOGNITION UNIT
201 EVS

1. An imaging device including:
an image sensor configured to acquire image data; and
a control unit that controls the image sensor, wherein
the control unit causes the image sensor to execute second imaging based on one or more imaging regions determined based on image data acquired by causing the image sensor to execute first imaging and resolution determined for each of the imaging regions, and
each of the imaging regions is a partial region of an effective pixel region in the image sensor.

2. The imaging device according to claim 1, wherein the control unit causes the image sensor to execute the first imaging to acquire the image data at resolution lower than maximum resolution of the image sensor.

3. The imaging device according to claim 1, wherein the control unit controls the image sensor to execute the first imaging in a cycle of once in a predetermined number of frames.

4. The imaging device according to claim 3, wherein the control unit causes the image sensor to execute the second imaging based on the one or more imaging regions determined based on the image data acquired in the first imaging of a frame before a current frame and the resolution.

5. The imaging device according to claim 4, wherein the control unit causes the image sensor to execute the second imaging based on the one or more imaging regions determined based on a result of recognition processing executed on the image data acquired in the first imaging and the resolution.

6. The imaging device according to claim 4, further including a signal processing unit that performs noise reduction for the image data acquired by the image sensor, wherein
the control unit determines the one or more imaging regions based on a region determined in noise reduction executed by the signal processing unit on the image data acquired in the first imaging of the frame before the current frame and causes the image sensor to execute the second imaging based on the one or more imaging regions and the resolution determined for each of the imaging regions.

7. The imaging device according to claim 4, wherein the control unit causes the image sensor to execute the second imaging based on the one or more imaging regions determined based on the image data acquired by the first imaging and a distance to an object detected by an external distance measuring sensor, and the resolution determined for each of the imaging regions.

8. The imaging device according to claim 4, wherein the control unit causes the image sensor to execute the second imaging based on the one or more imaging regions determined based on a vanishing point in the image data acquired by the first imaging and the resolution determined for each of the imaging regions.

9. The imaging device according to claim 4, wherein the control unit causes the image sensor to execute the second imaging based on the one or more imaging regions determined based on a horizon in the image data acquired by the first imaging and the resolution determined for each of the imaging regions.

10. An information processing device including a processing unit that determines the one or more imaging regions and the resolution for each of the imaging regions based on the image data input from the imaging device according to claim 1 and sets the determined one or more imaging regions and the resolution in the control unit.

11. An imaging system including:
the imaging device according to claim 1; and
the information processing device according to claim 10, wherein
the imaging device and the information processing device are connected via a predetermined network.

12. An imaging method including:
determining, by a processor, the one or more imaging regions and the resolution for each of the imaging regions based on the image data input from the imaging device according to claim 1; and
setting, by the processor, the determined one or more imaging regions and the determined resolution in the control unit.

13. An imaging device including:
an image sensor that acquires image data;
an event sensor that detects a luminance change for each of pixels; and
a control unit that controls the image sensor and the event sensor, wherein
the control unit controls the image sensor in response to a request from an information processing device connected via a predetermined network to acquire the image data and, when there is no request from the information processing device, controls the event sensor to generate a differential image including a pixel in which a luminance change is detected.

14. An information processing device including a processing unit that reconfigure image data of a current frame based on the image data and the differential image input from the imaging device according to claim 13, wherein
the processing unit requests the imaging device to acquire image data by the image sensor.

15. The information processing device according to claim 14, wherein the processing unit requests the imaging device to acquire the image data by the image sensor at a cycle of once in a predetermined number of frames.

16. The information processing device according to claim 14, wherein the processing unit requests the imaging device to acquire the image data by the image sensor when the image data of the current frame based on the image data and the differential image cannot be reconfigured.

17. An imaging device including:
an image sensor that acquires image data;
an event sensor that detects a luminance change for each of pixels;
a control unit that controls the image sensor and the event sensor, wherein
the image sensor acquires image data in each of a plurality of first partial regions obtained by dividing an effective pixel region,
the event sensor acquires a differential image in each of a plurality of second partial regions obtained by dividing the effective pixel region such that each of the second partial regions corresponds to any one of the first partial regions, and
the control unit controls the image sensor such that a first partial region from which image data is read is switched to any one of the plurality of first partial regions for each of frames and controls the event sensor such that a differential image of each of the second partial regions corresponding to the first partial regions from which the image data is not read is generated.

18. The imaging device according to claim 17, wherein the control unit switches the first partial region from which the image data is read such that a frame in which the image data is not generated is interposed between frames in which the image data is acquired from any of the plurality of first partial regions.

19. An imaging system including:
the imaging device according to claim 13; and
an information processing device including a processing unit that reconfigures image data of a current frame based on the image data and the differential image input from the imaging device.
